(19) United States
(12) Patent Application Publication
(10) Pub. No.: US 2026/0019760 A1
(43) Pub. Date: Jan. 15, 2026

(54) LOW ENERGY GROUPING OF PLAYBACK DEVICES

(71) Applicant: Sonos, Inc., Goleta, CA (US)

(72) Inventors: William Bennett Schoeler, Boston, MA (US); Brian Roberts, Boston, MA (US)

(21) Appl. No.: 19/264,310

(22) Filed: Jul. 9, 2025

Related U.S. Application Data
(60) Provisional application No. 63/669,525, filed on Jul. 10, 2024.

(51) Int. Cl. H04R 27/00; G06F 3/16; H04B 17/318

(52) U.S. Cl. CPC H04R 27/00; G06F 3/165; H04B 17/318; H04R 2420/07

(57) ABSTRACT

A playback device comprising a processor; and a communication interface operably connected to the processor and configured to facilitate communication over a network; and a non-transitory computer-readable medium comprising program instructions that are executable by the processor such that the playback device is configured to establish a Broadcast Isochronous Group (BIG) comprising another playback device, the BIG comprising a Broadcast Isochronous Stream (BIS) communicating an audio channel; establish a bidirectional link with the other playback device; play back, at a volume level, the audio channel in synchrony with the other playback device; receive, via the bidirectional link, a request to change the volume level; change the volume level to a new volume level in response to reception of the request; and play back, at the new volume level, the audio channel in synchrony with the other playback device.

### CROSS-REFERENCE TO RELATED APPLICATIONS

This application claims priority to co-pending U.S. Provisional Application No. 63/669,525 titled “LOW ENERGY GROUPING OF PLAYBACK DEVICES” and filed on Jul. 10, 2024, which is hereby incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices”, and began offering its first media playback systems for sale in 2005. The SONOS Wireless Home Sound System enables people to experience music from many sources via one or more networked playback devices. Through a software control application installed on a controller (for example, smartphone, tablet, computer, voice input device), one can play what she wants in any room having a networked playback device. Media content (for example, songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 2A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 3E is a block diagram of the network microphone device of FIGS. 3A through 3D.

FIG. 3F is a schematic diagram of an example voice input.

FIGS. 4A through 4D are schematic diagrams of a control device in various stages of operation in accordance with aspects of the disclosed technology.

FIG. 5 is front view of a control device.

FIG. 6 is a message flow diagram of a media playback system.

FIG. 7 is a block diagram of an audio playback system.

FIGS. 8A and 8B are a block diagram illustrating ungrouped and grouped states of an audio playback system.

FIG. 9 is a flow diagram illustrating a process of handing audio playback off between broadcasters.

FIG. 10 is a schematic diagram illustrating a method of establishing a low energy grouping (LEG) group.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Sonos has a long history of creating innovative wireless audio products that provide an intuitive, convenient, and straightforward user experience. For example, critics and end users alike have praised Sonos for developing wireless speaker systems that allow users to easily extend synchronous audio playback across multiple wireless playback devices. These audio systems can dynamically adapt to the requirements of a given situation, thereby providing a consistent user experience notwithstanding changing conditions. For instance, such systems can be deployed independent of network resources which may—or may not—be available in a given operating environment. Sonos has applied for patents for innovations embodied within such systems, such as U.S. Patent Pub. No. US 2023/0409280, filed 14 Jun. 2023, and titled “Techniques for Off-Net Synchrony Group Formation”; International Patent Pub. No. WO 2023/055742, filed 27 Sep. 2022, and titled “Synchronous Playback of Media Content by Off-Net Portable Devices”; and International Patent Pub. No. WO 2025/064375, filed 27 Sep. 2022, and titled “Wireless Communication Profile Management.” Each of these three patent documents is hereby incorporated herein by reference in its entirety.

As part of its ongoing innovation within this technological area, Sonos has identified shortcomings of existing wireless audio communication protocols and profiles and has developed wireless networking technology that can be leveraged to address these shortcomings to further enhance the user experience. As used herein, a “profile” can be understood as defining rules for how to use a wireless communication technology, such as BLUETOOTH, for a particular application, such as point-to-point or broadcast communication. A particular communication profile may dictate, for example, how participants discover one another, share capabilities, initiate communication, communicate data, and cease communication. For example, while the widely adopted BLUETOOTH Advanced Audio Distribution Profile (A2DP), also referred to as “BLUETOOTH Classic”, has been successful in delivering a quality audio listening experience, this profile suffers from certain shortcomings, such as being limited to one or more point-to-point arrangements between audio source devices and audio sink devices. In particular, A2DP is unable to ensure that multiple audio sink devices render their audio streams at exactly the same time such that playback is synchronized across the multiple devices. The more recently developed BLUETOOTH Low Energy (LE) Audio specification describes features that can be used to address certain shortcomings of A2DP. Examples of these features include a Broadcast Audio Scan Service (BASS), Periodic Advertising Synchronization Transfer (PAST), and the Public Broadcast Profile (PBP), marketed under the trademark AURACAST.

PBP defines a communication technique that enables an audio source device to broadcast an audio stream to an unlimited number of BLUETOOTH audio sink devices. Each of these audio streams is referred to as a Broadcast Isochronous Stream (BIS); one or more BISs can be grouped in a Broadcast Isochronous Group (BIG). For example, a left audio channel of a stereo pair may be broadcast by a first BIS, a right audio channel of the stereo pair may be broadcast by a second BIS, and both the first and second BISs may be included in the BIG. As a broadcast data stream, data packets transmitted in accordance with the Broadcast Audio profile are not individually addressed to any particular recipient device. These audio broadcasts can be open (in which case any in-range audio sink device may participate) or closed (in which case only audio sink devices with the correct passkey can participate). This allows, for example, an individual to share an audio stream, such as from a phone or tablet, to nearby users' playback devices. Any authorized device within range of the broadcaster can receive and render the broadcast audio stream. On a larger scale, location-based sharing allows a large public venue to broadcast multiple audio streams, thus allowing any number of listeners to configure their playback devices to receive, for example, public address announcements in a particular language.

While PBP envisions enhanced functionality vis-n-vis A2DP, PBP omits features helpful to provide a desired user experience in some examples. For instance, while PBP supports an unlimited number of audio sink devices, PBP does not provide a rich bidirectional communication path. However, bidirectional communications between members of a group of playback devices may be helpful to allow all group members to contribute to the overall playback experience, such as through selecting audio to be played back, controlling playback volume, and participating in specialized grouping, such as stereo pairing. Moreover, a PBP initiated data stream will typically transmit at a relatively high (or maximum) allotted power to reach as many potential recipients as possible. Broadcast streams will therefore have a larger range, but higher power consumption. However, depending on the broadcast environment, high power transmissions may be avoidable and battery life may be extended without sacrificing a user's experience by, for example, decreasing transmit power under favorable conditions.

In view of these and other shortcomings, the inventors have developed low energy grouping (LEG) technology that supplements and extends PBP to achieve a number of objectives for a user's experience. A brief description of some of these objectives, and the features of LEG that achieve the objectives, follows.

In some examples, LEG enables a seamless and responsive user experience out-of-the-box. LEG implements a control plane that supplements PBP and other BLUETOOTH LE features to enable bidirectional, wireless, and routerless communications between playback devices. Through LEG a user can group or ungroup playback devices easily and quickly, with or without a separate control device. In addition, a user can switch the active source of audio dynamically, while maintaining a prior grouping of playback devices.

In some examples, LEG supports a wide variety of audio sources. Through LEG the active source of audio is not restricted to a particular device type or manufacturer because LEG does not require the source to support PBP or other BLUETOOTH LE profiles or features. By design LEG does not use the source for any direct broadcasting, or direct coordination between devices. Rather LEG provides for an application programming interface (API) that allows a control device to display grouping and control information. As a consequence of this architecture, line-in, universal serial bus (USB), and other audio sources can be distributed by a LEG broadcaster in the same manner as audio received from BLUETOOTH sources.

In some examples, LEG is power optimized. Via the LEG control plane, handoff between sources of audio is accomplished while minimizing unnecessary advertising and scanning. Moreover, LEG sets many parameters that affect power consumption to a minimum initial state and scales up as needed to achieve the desired user experience, rather than setting the parameters to a high or maximum initial state and scaling down as permitted. In some examples, LEG receivers detect and quantify broadcast performance into one or more metrics and communicate the metrics to the LEG broadcaster via one or more messages. In these examples, the LEG broadcaster, in turn, adjusts transmission parameters such as retransmission count, encoding quality/type, and transmission power level to minimize power consumption while achieving desired audio performance.

In some examples, LEG is authenticated. LEG broadcasts can be closed to devices other than those having a broadcast code, as specified by PBP, to prevent bad actors from affecting the user experience. In certain examples, LEG broadcasters generate the broadcast code and communicate the broadcast code to LEG receivers through an out-of-band (OOB) process. This OOB process may involve a variety of devices and communication paths. For instance, in some examples, the GOB process involves a control device and messages sent and received between the control device and playback devices that are to be members of a LEG group. In other examples, the GOB process involves communication paths between the playback devices established through transducers (e.g., audio transducers, accelerometers, proximity sensors, etc.) incorporated within the playback devices. In certain examples, LEG receivers with the broadcast code can communicate messages specifying acceptable audio commands to the LEG broadcaster to control audio parameters, such as volume settings, play/pause/repeat settings, track selection, and stereo/mono playback settings among others. In some examples, the LEG broadcaster may still allow playback devices without the broadcast code to join as a PBP broadcast receiver, so that these playback devices can render audio data streamed via the broadcast, but such playback devices would be unable to communicate a message specifying an acceptable audio command.

In some examples, LEG is adaptable to changing network topologies. In these examples, LEG shields programs from the specifics of the underlying network topology of the PBP Broadcast/Receiver and BLE Central/Peripheral roles. As such, devices that are grouped adjust their roles as needed to remain grouped even in situations such as Broadcasters going out of range or losing power unexpectedly. To accomplish this, Broadcaster Handoff and Broadcaster Recovery mechanisms are implemented.

In some examples, LEG supports a variety of playback device groupings. Via LEG control messages, LEG groups with various characteristics can be established to optimize the user experience. For instance, in some examples, a LEG receiver can be set (e.g. prior to or during broadcast) to render a preferred stereo channel (e.g., via a control device or a user interface included within the playback device incorporating the LEG receiver). In some examples, a LEG broadcaster may enable stereo playback only if at least two playback devices are included in a LEG group including the LEG broadcaster and at least one of them has been set to render the right or left stereo channel. In some examples, LEG groups are set to distribute and render mono playback by default. Additionally or alternatively, LEG supports bonded groups and multichannel audio content beyond stereo, in some examples.

While some examples described herein may refer to functions performed by given actors such as “users”, “listeners”, and/or other entities, it should be understood that such references are for purposes of explanation only. The claims should not be interpreted to require action by any such example actor unless explicitly required by the language of the claims themselves.

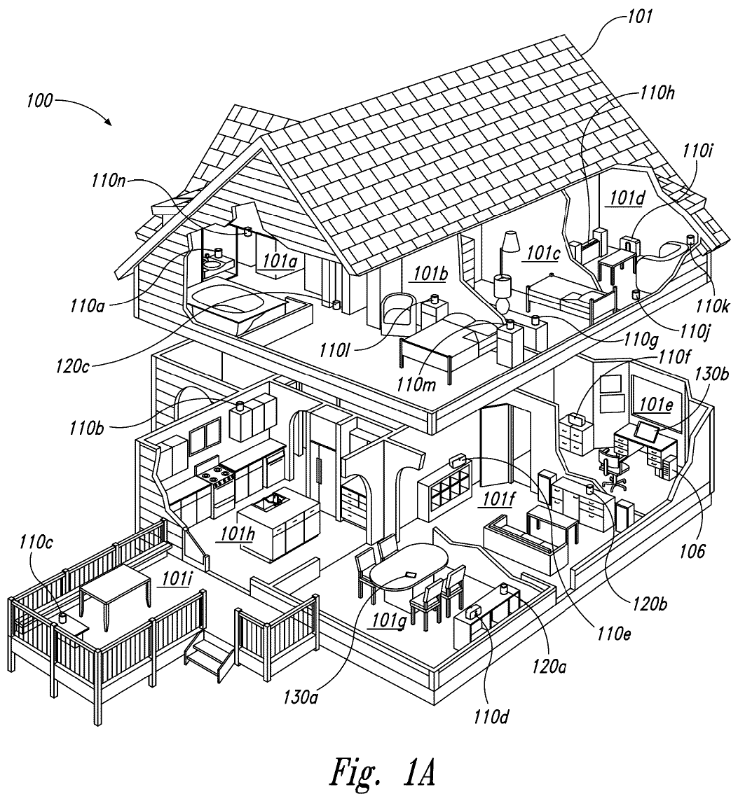

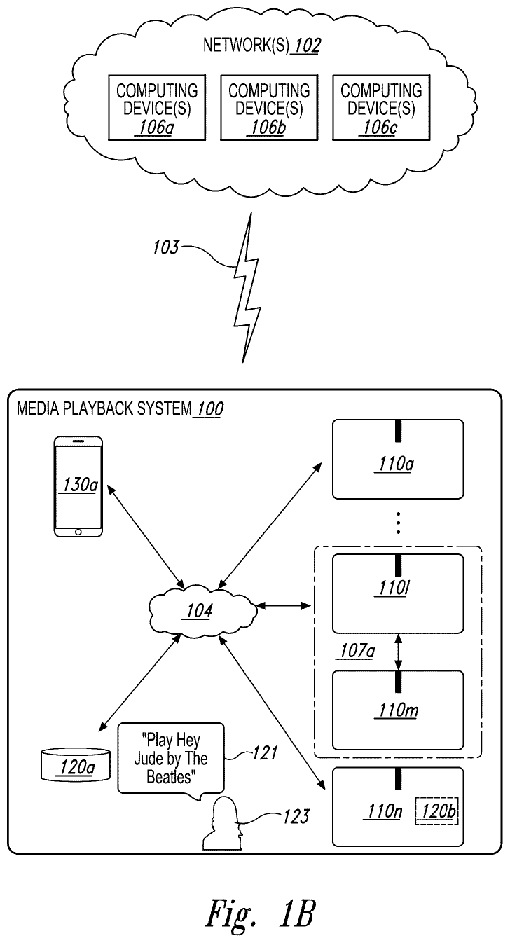

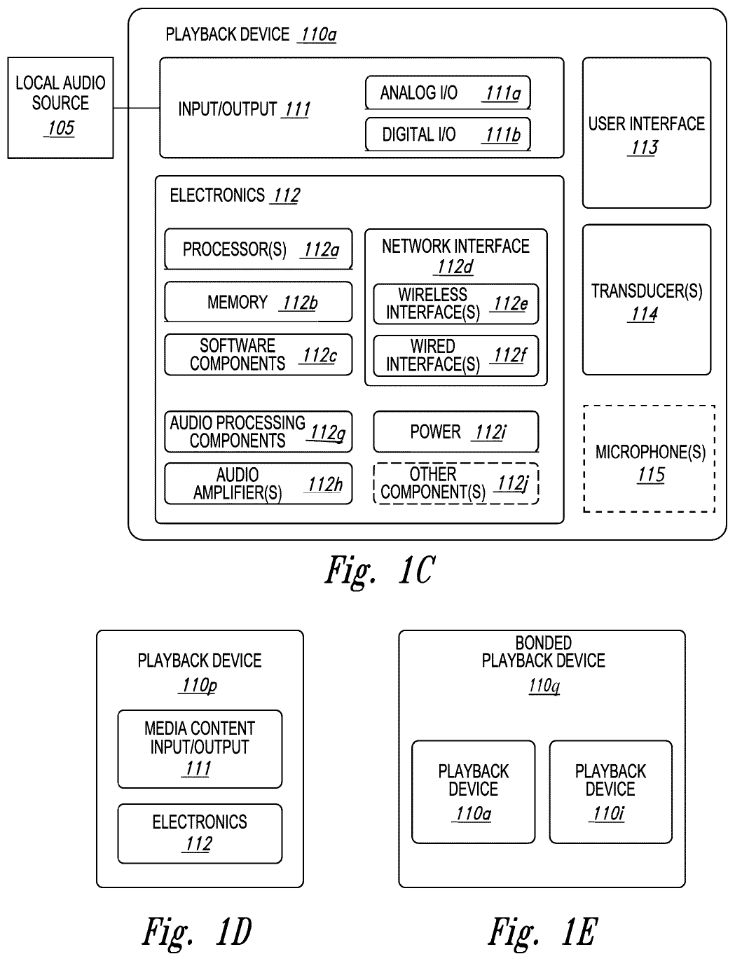

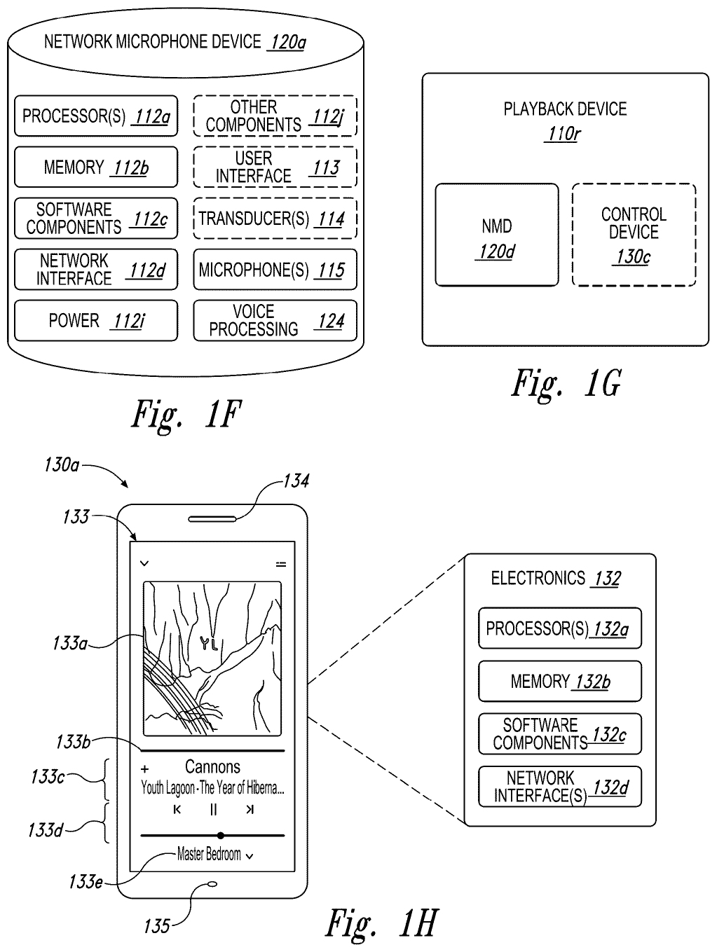

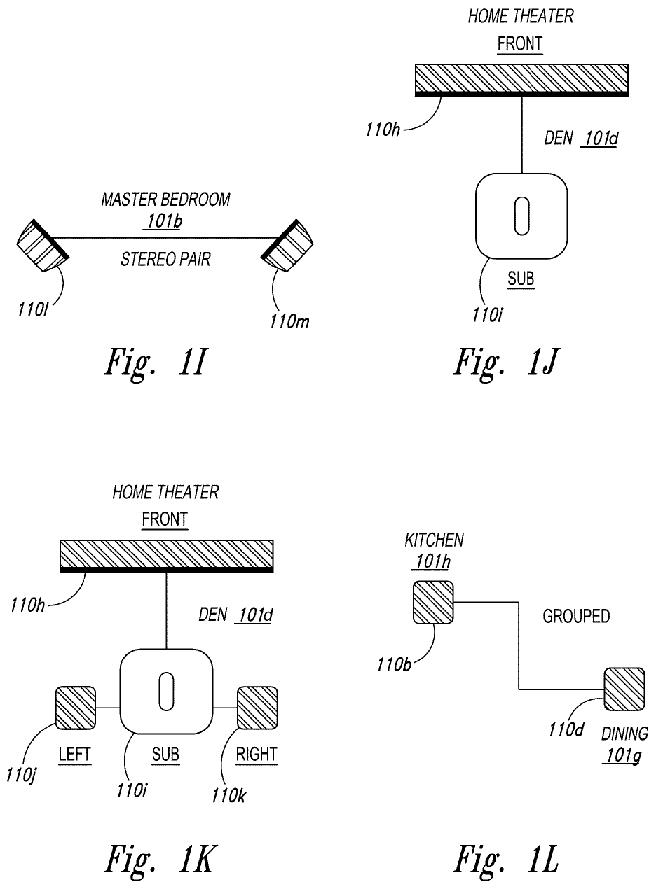

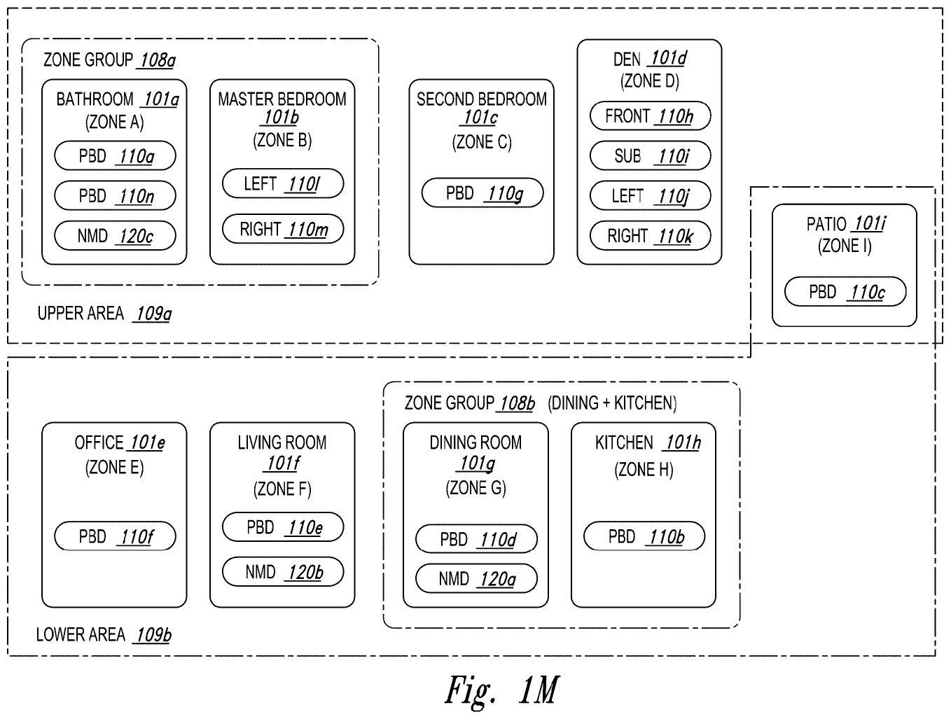

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (for example, a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (that is, a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (for example, one or more remote servers, one or more local devices, and so forth) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (for example, presence of a user in a kitchen, detection of a coffee machine operation, and so forth). In some embodiments, for example, the media playback system 100 is configured to play back audio from a first playback device (for example, the playback device 110a) in synchrony with a second playback device (for example, the playback device 110b). Interactions between the playback devices 110, NMDs 120, and/or control devices 130 of the media playback system 100 configured in accordance with the various embodiments of the disclosure are described in greater detail below with respect to FIGS. 1B through 6.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (for example, a restaurant, mall, airport, hotel, a retail or other store), one or more vehicles (for example, a sports utility vehicle, bus, car, a ship, a boat, an airplane, and so forth), multiple environments (for example, a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, master bedroom 101b, and the den 101d each include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I through 1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled “System and method for synchronizing operations among a plurality of independently clocked digital data processing devices”, which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (for example, one or more Global System for Mobiles (GSM) networks, Code Division Multiple Access (CDMA) networks, Long-Term Evolution (LTE) networks, 5G communication networks, and/or other suitable data transmission protocol networks), and so forth. The cloud network 102 is configured to deliver media content (for example, audio content, video content, photographs, social media content, and so forth) to the media playback system 100 in response to a request transmitted from the media playback system 100 via the links 103. In some embodiments, the cloud network 102 is further configured to receive data (for example, voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, and so forth. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (for example, one or more of the playback devices 110, NMDs 120, and/or control devices 130) of the media playback system 100. The network 104 can include, for example, a wireless network (for example, a WI-FI network, a BLUETOOTH network, a Z-WAVE network, a ZIGBEE network, and/or other suitable wireless communication protocol network) and/or a wired network (for example, a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, and so forth transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (for example, one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (for example, a household or commercial facility WI-FI network). In some embodiments, the links 103 and the network 104 comprise one or more of the same networks. In some aspects, for example, the links 103 and the network 104 comprise a telecommunication network (for example, an LTE network, a 5G network, and so forth). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (for example, title, artist, album, track length, and so forth) and other associated information (for example, URIs, URLs, and so forth) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I through 1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (for example, a VAS operated by one or more of SONOS, AMAZON, GOOGLE, APPLE, MICROSOFT, and so forth). The computing device 106c can receive the voice input data from the NMD 120a via the network 104 and the links 103.

In response to receiving the voice input data, the computing device 106c processes the voice input data (that is, “Play Hey Jude by The Beatles”), and determines that the processed voice input includes a command to play a song (for example, “Hey Jude”). In some embodiments, after processing the voice input, the computing device 106c accordingly transmits commands to the media playback system 100 to play back “Hey Jude” by the Beatles from a suitable media service (for example, via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (for example, one or more wires, cables, and/or other suitable communication links configured to carry analog signals) and/or a digital I/O 111b (for example, one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital I/O 111b comprise interfaces (for example, ports, plugs, jacks, and so forth) configured to receive connectors of cables transmitting analog and digital signals, respectively, without necessarily including cables.

The playback device 110a, for example, can receive media content (for example, audio content comprising music and/or other sounds) from a local audio source 105 via the input/output 111 (for example, a cable, a wire, a PAN, a BLUETOOTH connection, an ad hoc wired or wireless communication network, and/or another suitable communication link). The local audio source 105 can comprise, for example, a mobile device (for example, a smartphone, a tablet, a laptop computer, and so forth) or another suitable audio component (for example, a television, a desktop computer, an amplifier, a phonograph (such as n LP turntable), a Blu-ray player, a memory storing digital media files, and so forth). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (for example, one or more buttons, knobs, dials, touch-sensitive surfaces, displays, touchscreens, and so forth), and one or more transducers 114 (referred to hereinafter as “the transducers 114”). The electronics 112 are configured to receive audio from an audio source (for example, the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (for example, a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (for example, one or more power supplies, power cables, power receptacles, batteries, induction coils, Power-over Ethernet (POE) interfaces, and/or other suitable sources of electric power). In some embodiments, the electronics 112 optionally include one or more other components 112j (for example, one or more sensors, video displays, touchscreens, battery charging bases, and so forth).

The processors 112a can comprise clock-driven computing component(s) configured to process data, and the memory 112b can comprise a computer-readable medium (for example, a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (for example, one or more of the computing devices 106a-c (FIG. 1B)), and/or another one of the playback devices 110. In some embodiments, the operations further include causing the playback device 110a to send audio data to another one of the playback devices 110a and/or another device (for example, one of the NMDs 120). Certain embodiments include operations causing the playback device 110a to pair with another of the one or more playback devices 110 to enable a multi-channel audio environment (for example, a stereo pair, a bonded zone, and so forth).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (for example, the playback devices 110, NMDs 120, control devices 130) of the media playback system 100. In some aspects, for example, the state data is shared during predetermined intervals of time (for example, every 5 seconds, every 10 seconds, every 60 seconds, and so forth) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (for example, audio content, video content, text, photographs) and other signals (for example, non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (for example, a suitable interface comprising one or more antennae) can be configured to wirelessly communicate with one or more other devices (for example, one or more of the other playback devices 110, NMDs 120, and/or control devices 130) that are communicatively coupled to the network 104 (FIG. 1B) in accordance with a suitable wireless communication protocol (for example, WI-FI, BLUETOOTH, LTE, and so forth). In some embodiments, the network interface 112d optionally includes a wired interface 112f (for example, an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (for example, the input/output 111).

The audio components 112g are configured to process and/or filter data comprising media content received by the electronics 112 (for example, via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, and so forth. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (for example, linear gain power amplifiers, class-A amplifiers, class-B amplifiers, class-AB amplifiers, class-C amplifiers, class-D amplifiers, class-E amplifiers, class-F amplifiers, class-G amplifiers, class-H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (for example, one or more speakers and/or speaker drivers) receive the amplified audio signals from the amplifier 112h and render or output the amplified audio signals as sound (for example, audible sound waves having a frequency between about 20 hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (for example, subwoofers, woofers), mid-range frequency transducers (for example, mid-range transducers, mid-woofers), and one or more high frequency transducers (for example, one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos presently offers (or has offered) for sale certain playback devices including, for example, a “SONOS ONE”, “PLAY:1”, “PLAY:3”, “PLAY:5”, “PLAYBAR”, “PLAYBASE”, “CONNECT:AMP”, “CONNECT”, “AMP”, “PORT”, and “SUB”. Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (for example, over-the-ear headphones, on-ear headphones, in-ear earphones, and so forth). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

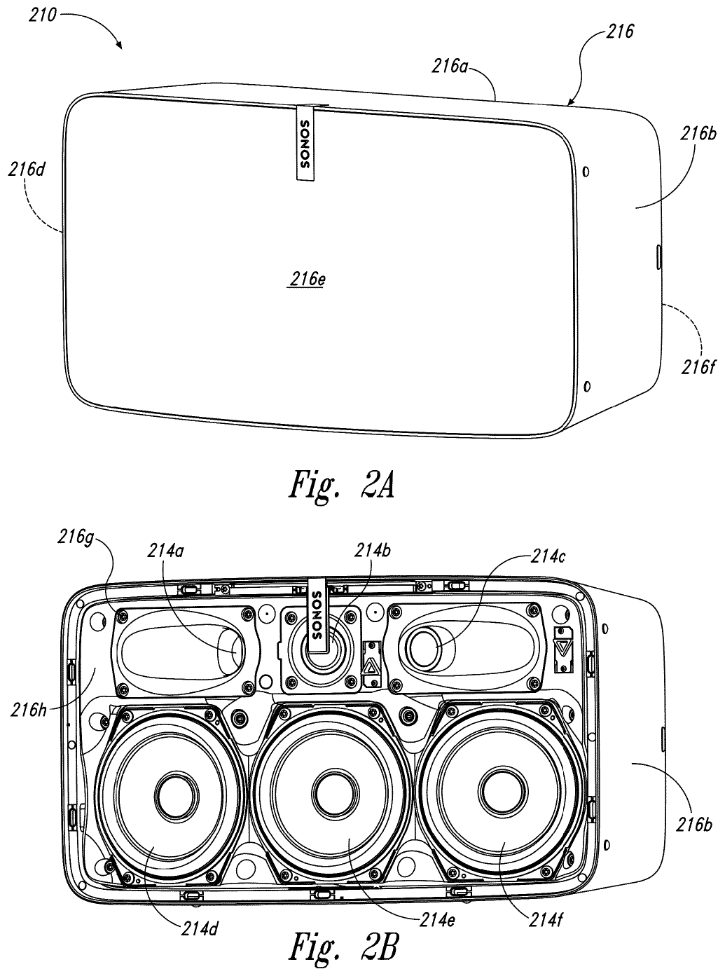

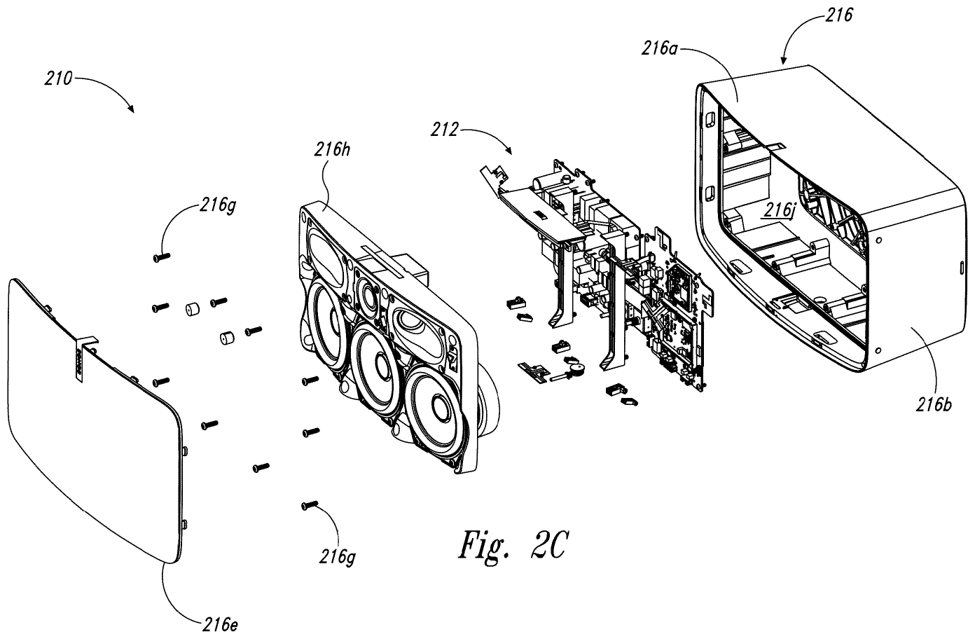

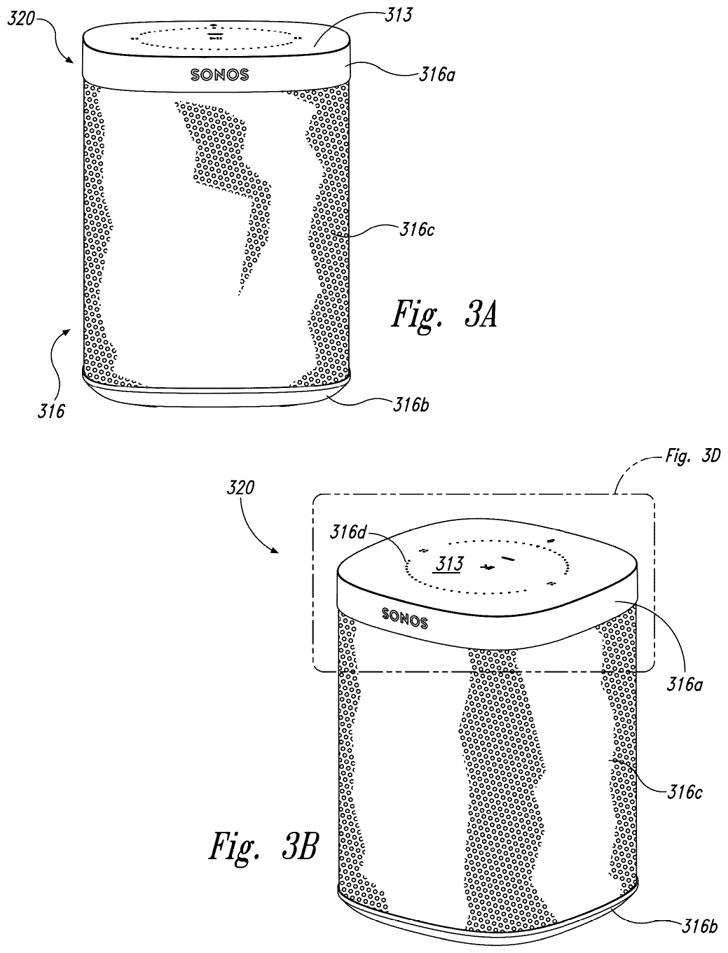

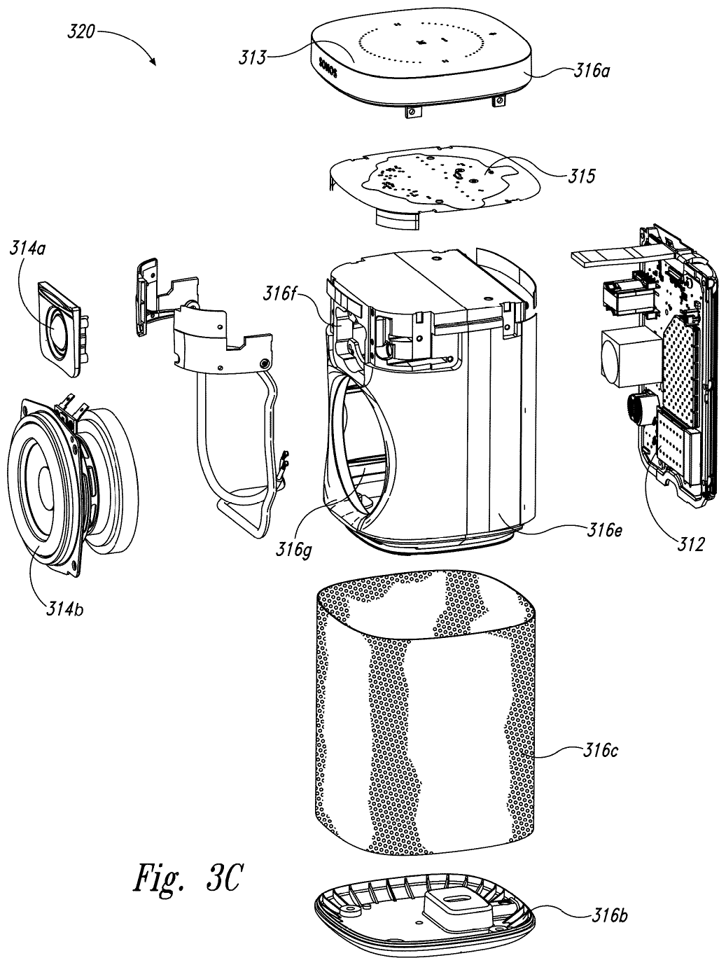

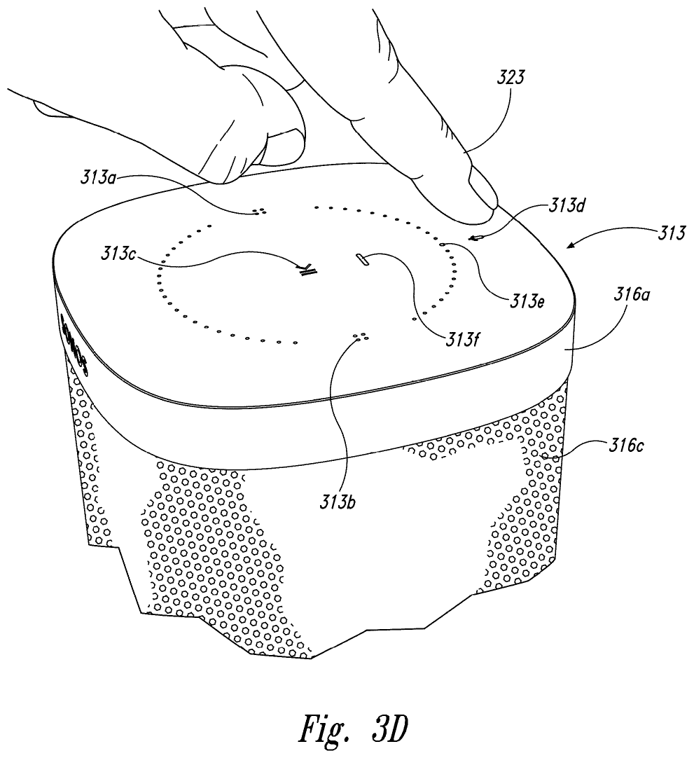

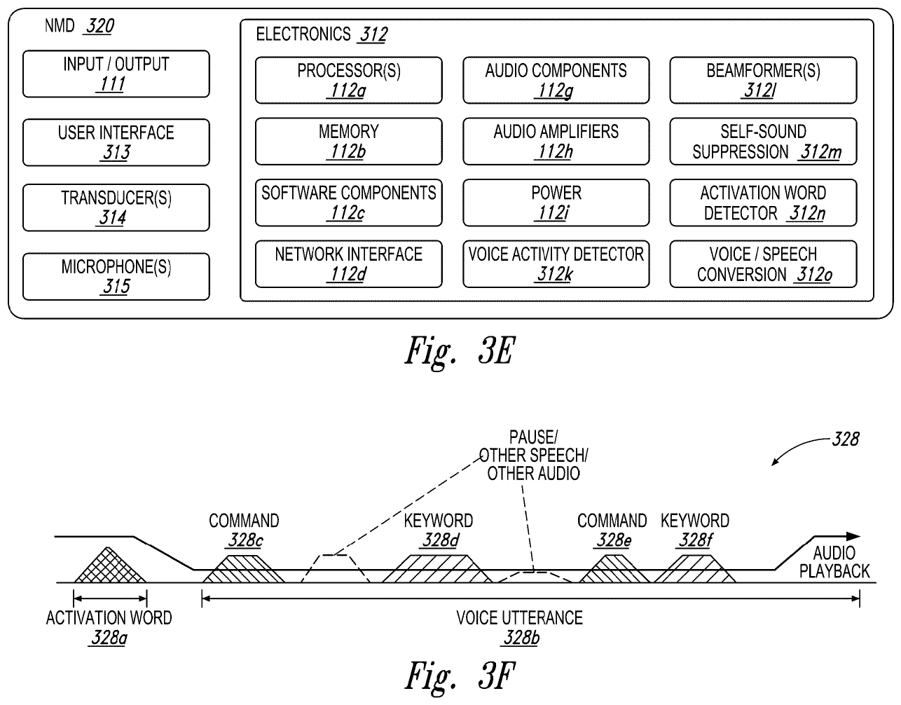

FIG. 1E is a block diagram of a bonded playback device 110q comprising the playback device 110a (FIG. 1C) sonically bonded with the playback device 110i (for example, a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (for example, the playback device 110a of FIG. 1C) and/or paired or bonded playback devices (for example, the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A through 3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (for example, one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, and so forth. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (for example, one or more sensors, cameras, thermometers, barometers, hygrometers, and so forth).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (for example, the user interface 113 of FIG. 1C) configured to receive user input (for example, touch input, voice input, and so forth) without a separate control device. In other embodiments, however, the playback device 110r receives commands from another control device (for example, the control device 130a of FIG. 1B). Additional NMD embodiments are described in further detail below with respect to FIGS. 3A through 3F.

Referring again to FIG. 1F, the microphones 115 are configured to acquire, capture, and/or receive sound from an environment (for example, the environment 101 of FIG. 1A) and/or a room in which the NMD 120a is positioned. The received sound can include, for example, vocal utterances, audio played back by the NMD 120a and/or another playback device, background voices, ambient sounds, and so forth. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa”. Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (for example, NEST thermostat), an illumination device (for example, a PHILIPS HUE lighting device), or a media playback device (for example, a SONOS playback device). For example, a user might speak the activation word “Alexa” followed by the utterance “set the thermostat to 68 degrees” to set a temperature in a home (for example, the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A through 3F.

d. Suitable Control Devices

FIG. 1H is a partial schematic diagram of the control device 130a (FIGS. 1A and 1B). As used herein, the term “control device” can be used interchangeably with “controller” or “control system”. Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (for example, an iPhone™, an Android phone, and so forth) on which media playback system controller application software is installed. In some embodiments, the control device 130a comprises, for example, a tablet (for example, an iPad™), a computer (for example, a laptop computer, a desktop computer, and so forth), and/or another suitable device (for example, a television, an automobile audio head unit, an IoT device, and so forth). In certain embodiments, the control device 130a comprises a dedicated controller for the media playback system 100. In other embodiments, as described above with respect to FIG. 1G, the control device 130a is integrated into another device in the media playback system 100 (for example, one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (for example, infrared, radio, wired standards including IEEE 802.3, wireless standards including IEEE 802.11a, 802.11b, 802.11g, 802.11n, 802.11ac, 802.15, 4G, LTE, and so forth). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, and so forth. The transmitted and/or received data can include, for example, playback device control commands, state variables, playback zone and/or zone group configurations. For instance, based on user input received at the user interface 133, the network interface 132d can transmit a playback device control command (for example, volume control, audio playback control, audio content selection, and so forth) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (for example, album art, lyrics, videos, and so forth), a playback status indicator 133b (for example, an elapsed and/or remaining time indicator), media content information region 133c, a playback control region 133d, and a zone indicator 133e. The media content information region 133c can include a display of relevant information (for example, title, artist, album, genre, release year, and so forth) about media content currently playing and/or media content in a queue or playlist. The playback control region 133d can include selectable (for example, via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, and so forth. The playback control region 133d may also include selectable icons to modify equalization settings, playback volume, and/or other suitable playback actions. In the illustrated embodiment, the user interface 133 comprises a display presented on a touch screen interface of a smartphone (for example, an iPhone™, an Android phone, and so forth). In some embodiments, however, user interfaces of varying formats, styles, and interactive sequences may alternatively be implemented on one or more network devices to provide comparable control access to a media playback system.

The one or more speakers 134 (for example, one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (for example, one of the playback devices 110). Similarly, in some embodiments the control device 130a is configured as an NMD (for example, one of the NMDs 120), receiving voice commands and other sounds via the one or more microphones 135.

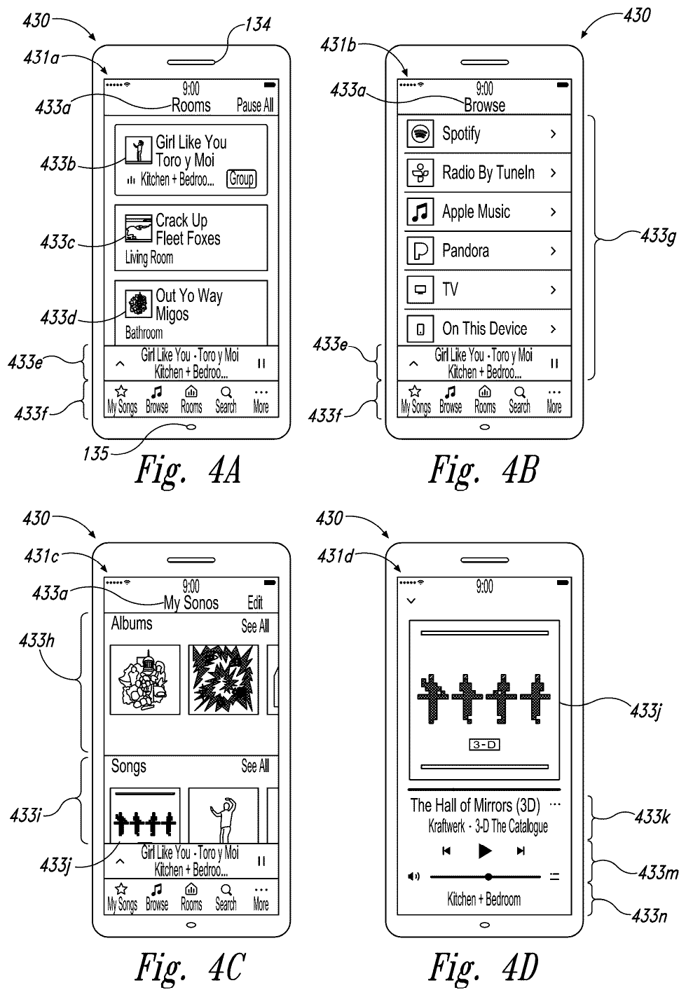

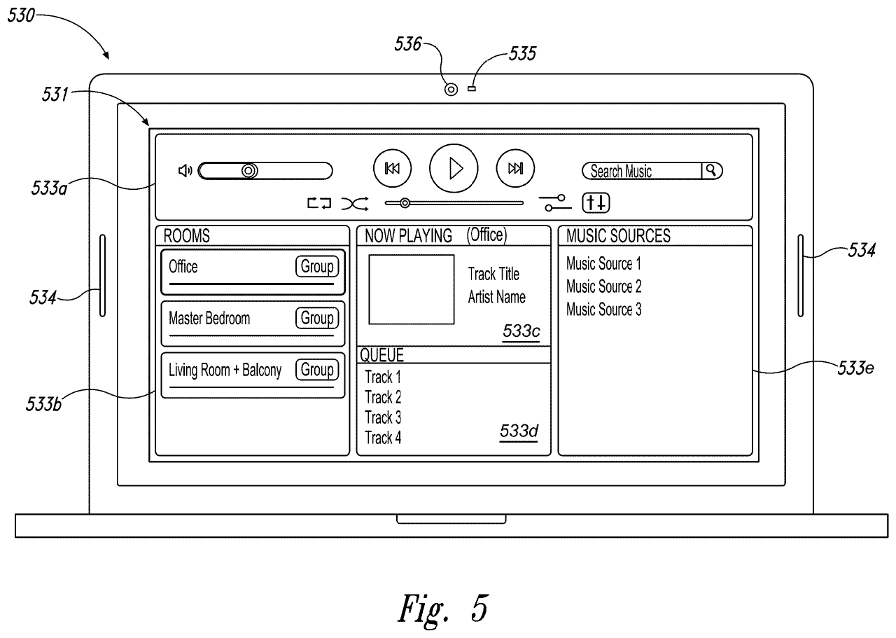

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (for example, voice, audible sound, and so forth) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (for example, a thermostat, an IoT device, a network device, and so forth) comprising a portion of the electronics 132 and the user interface 133 (for example, a touch screen) without any speakers or microphones. Additional control device embodiments are described in further detail below with respect to FIGS. 4A through 4D and 5.

e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (for example, a left playback device) can be bonded to the playback device 110m (for example, a right playback device) to form Zone B. Bonded playback devices may have different playback responsibilities (for example, channel responsibilities). In another implementation described below, multiple playback devices may be merged to form a single zone. For example, the playback device 110h (for example, a front playback device) may be merged with the playback device 110i (for example, a subwoofer), and the playback devices 110j and 110k (for example, left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing”.

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (that is, a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in subsequently referenced U.S. Pat. No. 10,499,146.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-1. The Zones A-1 may be grouped and ungrouped in numerous ways. For example, three, four, five, or more (for example, all) of the Zones A-1 may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, zone group 108b can be assigned a name such as “Dining+Kitchen”, as shown in FIG. 1M. In some embodiments, a zone group may be given a unique name selected by a user.

Certain data may be stored in a memory of a playback device (for example, the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (for example, tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the den may indicate that the den is not grouped with other zones but includes bonded playback devices 110h-110k. Identifiers associated with the dining room may indicate that the dining room is part of the Dining+Kitchen zone group 108b and that devices 110b and 110d are grouped (FIG. 1L). Identifiers associated with the kitchen may indicate the same or similar information by virtue of the kitchen being part of the Dining+Kitchen zone group 108b. Other example zone variables and identifiers are described below.

In yet another example, the memory may store variables or identifiers representing other associations of zones and zone groups, such as identifiers associated with areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an area may be used to invoke a cluster of zone groups and/or zones that share one or more zones and/or zone groups of another cluster. In another aspect, this differs from a zone group, which does not share a zone with another zone group. Further examples of techniques for implementing areas may be found, for example, in U.S. Pat. No. 10,712,997, filed 21 Aug. 2017, and titled “Room Association Based on Name”, and U.S. Pat. No. 8,483,853, filed 11 Sep. 2007, and titled “Controlling and manipulating groupings in a multi-zone media system”. Each of these patents is incorporated herein by reference in its entirety. In some embodiments, the media playback system 100 may not implement areas, in which case the system may not store variables associated with areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A through 2C together, the playback device 210 comprises a housing 216 that includes an upper portion 216a, a right or first side portion 216b, a lower portion, a left or second side portion 216d, the grille 216e, and a rear portion 216f. A plurality of fasteners 216g (for example, one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (for example, the electronics 112 of FIG. 1C) are configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (for example, tweeters) can be configured to output high frequency sound (for example, sound waves having a frequency greater than about 2 kHz). The transducers 214d-f (for example, mid-woofers, woofers, midrange speakers) can be configured output sound at frequencies lower than the transducers 214a-c (for example, sound waves having a frequency lower than about 2 kHz). In some embodiments, the playback device 210 includes a number of transducers different than those illustrated in FIGS. 2A through 2C. For example, as described in further detail below with respect to FIGS. 3A through 3C, the playback device 210 can include fewer than six transducers (for example, one, two, three). In other embodiments, however, the playback device 210 includes more than six transducers (for example, nine, ten). Moreover, in some embodiments, all or a portion of the transducers 214 are configured to operate as a phased array to desirably adjust (for example, narrow or widen) a radiation pattern of the transducers 214, thereby altering a user's perception of the sound emitted from the playback device 210.

In some examples, a filter is axially aligned with the transducer 214b. The filter can be configured to desirably attenuate a predetermined range of frequencies that the transducer 214b outputs to improve sound quality and a perceived sound stage output collectively by the transducers 214. In some embodiments, however, the playback device 210 omits the filter. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A through 3C, the NMD 320 includes a housing 316 comprising an upper portion 316a, a lower portion 316b and an intermediate portion 316c (for example, a grille). A plurality of ports, holes or apertures 316d in the upper portion 316a allow sound to pass through to one or more microphones 315 (FIG. 3C) positioned within the housing 316. The one or more microphones 315 are configured to receive sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (for example, a tweeter) and a second transducer 314b (for example, a mid-woofer, a midrange speaker, a woofer). In other embodiments, however, the NMD 320 includes a single transducer, or more than two (for example, two, five, six) transducers. In certain embodiments, the NMD 320 omits the transducers 314a and 314b altogether.

Electronics 312 (FIG. 3C) includes components configured to drive the transducers 314a and 314b, and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, and so forth. In some embodiments, the electronics 312 includes additional suitable components (for example, proximity or other sensors).

Referring to FIG. 3D, the user interface 313 includes a plurality of control surfaces (for example, buttons, knobs, capacitive surfaces) including a first control surface 313a (for example, a previous control), a second control surface 313b (for example, a next control), and a third control surface 313c (for example, a play and/or pause control) that can be adjusted by a user 323. A fourth control surface 313d is configured to receive touch input corresponding to activation and deactivation of the one or microphones 315. A first indicator 313e (for example, one or more light emitting diodes (LEDs) or another suitable illuminator) can be configured to illuminate only when the one or more microphones 315 are activated. A second indicator 313f (for example, one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A through 3D together, the NMD 320 is configured to receive voice commands from one or more adjacent users via the one or more microphones 315. As described above with respect to FIG. 1B, the one or more microphones 315 can acquire, capture, or record sound in a vicinity (for example, a region within 10 m or less of the NMD 320) and transmit electrical signals corresponding to the recorded sound to the electronics 312. The electronics 312 can process the electrical signals and can analyze the resulting audio data to determine a presence of one or more voice commands (for example, one or more activation words). In some embodiments, for example, after detection of one or more suitable voice commands, the NMD 320 is configured to transmit a portion of the recorded audio data to another device and/or a remote server (for example, one or more of the computing devices 106 of FIG. 1IB) for further analysis. The remote server can analyze the audio data, determine an appropriate action based on the voice command, and transmit a message to the NMD 320 to perform the appropriate action. For instance, a user may speak “Sonos, play Michael Jackson”. The NMD 320 can, via the one or more microphones 315, record the user's voice utterance, determine the presence of a voice command, and transmit the audio data having the voice command to a remote server (for example, one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (for example, play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (for example, the network 104 of FIG. 1B), a remote server (for example, one or more of the remote computing devices 106 of FIG. 1B), and so forth. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 3120 (for example, voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, and so forth. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise.

The activation word detector components 312n are configured to monitor and analyze received audio to determine if any activation words (for example, wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (for example, AMAZON's ALEXA, APPLE's SIRI, or MICROSOFT's CORTANA) can each use a different activation word for invoking their respective voice service. To support multiple services, the activation word detector 312n may run the received audio through the activation word detection algorithm for each supported voice service in parallel.

The speech/text conversion components 3120 may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 328a can be a known activation word, such as “Alexa”, which is associated with AMAZON's ALEXA. In other embodiments, however, the voice input 328 may not include an activation word. In some embodiments, a network microphone device may output an audible and/or visible response upon detection of the activation word portion 328a. In addition, or alternately, an NMD may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, and so forth. In this example, the keywords may be one or words identifying one or more zones in which the music is to be played, such as the living room and the dining room shown in FIG. 1A. In some examples, the voice utterance portion 328b can include other information, such as detected pauses (for example, periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 328a. The media playback system 100 may restore the volume after processing the voice input 328, as shown in FIG. 3F. Such a process can be referred to as ducking, examples of which are disclosed in U.S. Pat. No. 10,499,146, which is incorporated by reference herein in its entirety.

FIGS. 4A through 4D are schematic diagrams of a control device 430 (for example, the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (that is, “Rooms”). A selected group region 433b displays audio content information (for example, artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (that is, the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (for example, Spotify, Radio by Tunein, Apple Music, Pandora, Amazon, TV, local music, line-in) through which the user can browse and from which the user can select media content for play back via one or more playback devices (for example, one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (for example, album art) corresponding to individual albums, stations, or playlists. A second media content region 433i can include graphical representations (for example, album art) corresponding to individual songs, tracks, or other media content. If the user selects a graphical representation 433j (FIG. 4C), the control device 430 can be configured to begin play back of audio content corresponding to the graphical representation 433j and output a fourth user interface display 431d that includes an enlarged version of the graphical representation 433j, media content information 433k (for example, track name, artist, album), transport controls 433m (for example, play, previous, next, pause, volume), and indication 433n of the currently selected group and/or zone name.

FIG. 5 is a schematic diagram of a control device 530 (for example, a laptop computer, a desktop computer). The control device 530 includes transducers 534, a microphone 535, and a camera 536. A user interface 531 includes a transport control region 533a, a playback status region 533c, a playback zone region 533b, a playback queue region 533d, and a media content source region 533e. The transport control region comprises one or more controls for controlling media playback including, for example, volume, previous, play/pause, next, repeat, shuffle, track position, crossfade, equalization, and so forth. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, and so forth. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

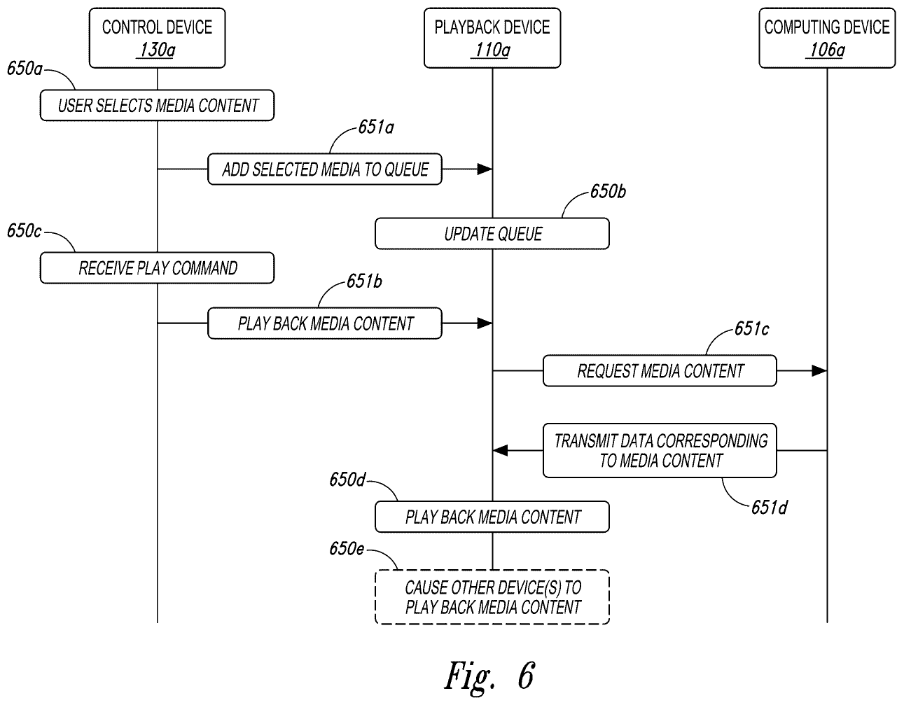

FIG. 6 is a message flow diagram illustrating data exchanges between devices of the media playback system 100 (FIGS. 1A through 1M).

At step 650a, the media playback system 100 receives an indication of selected media content (for example, one or more songs, albums, playlists, podcasts, videos, stations) via the control device 130a. The selected media content can comprise, for example, media items stored locally on one or more devices (for example, the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A through 1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the computing device 106a requesting the selected media content. The computing device 106a, in response to receiving the message 651c, transmits a message 651d comprising data (for example, audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the computing device 106a, and begin playback of the selected media content in response to a message from the playback device 110a such that all of the devices in the group play back the selected media content in synchrony.

### IV. Low Energy Grouping (LEG) of Playback Devices

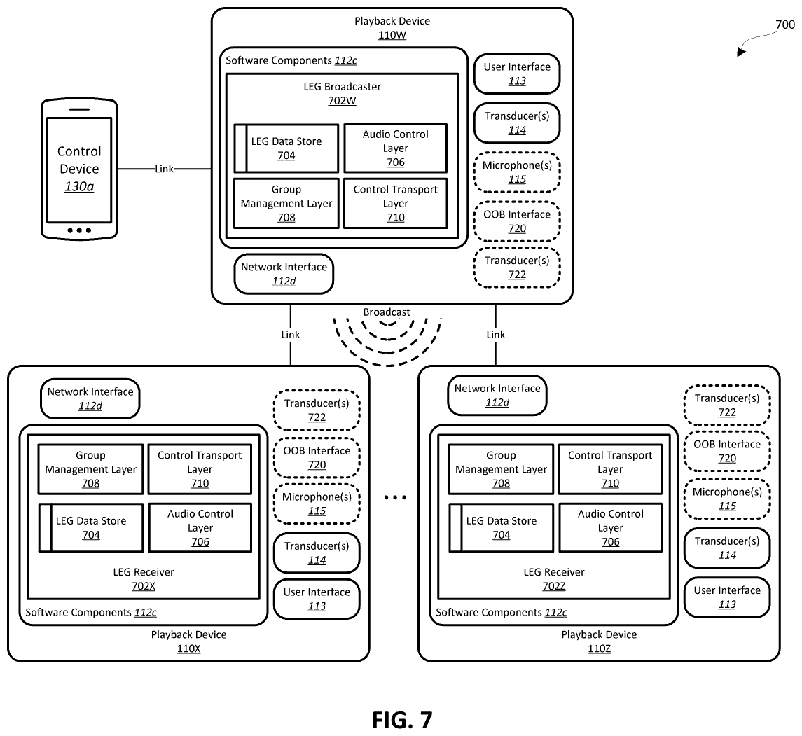

FIG. 7 illustrates an audio playback system 700 configured to form, adapt, and dissolve groups of playback devices that synchronously play back audio content. In at least some examples, the system 700 is configured to execute processes that extend and supplement the BLUETOOTH LE Audio specification to ease group formation, control groupwise audio playback, and adapt the group to changing conditions. As shown in FIG. 7, the system 700 includes the control device 130a introduced in FIG. 1A and three or more playback devices 110 introduced in FIG. 1A (shown as playback devices 110W-110Z). Each of the playback devices 110W-110Z includes, in addition to at least some of the features of playback devices 110 described above, LEG code and configuration data 702 (shown as LEG broadcaster 702W and LEG receivers 702X-702Z), an OOB interface 720, and one or more transducers 722, which are rendered in dashed lines to indicate their optionality. The LEG code and configuration data 702 includes a LEG data store 704, an audio control layer 706, a group management layer 708, and a control transport layer (CTL) 710.

In some examples, the transducers 722 and the OOB interface 720 may be configured to communicate using a first protocol stack (e.g., BLUETOOTH, RFID, IrDA, NFC, a proprietary protocol stack, etc.). In these embodiments, the transducer 722 converts other forms of energy into electrical signals and the OOB interface 720 modulates and demodulates the electrical signals to support the protocol stacks. For instance, the transducer 722 may be implemented as an infrared sensor, a visible light sensor (e.g., a camera), an acoustic transceiver (e.g., in addition to or separate from the microphones 115 and the transducers 114), an RFID scanner, an NFC reader, an antenna, an accelerometer, or the like. The GOB interface 720 may operate on the electrical signals generated by these various types of transducers in support of various protocol stacks enumerated above.

In some examples, the LEG code and configuration data 702 can be set (e.g., via one or more configurable parameters stored in the LEG data store 704) to operate in either of two roles—a broadcaster role or a receiver role. The LEG code may be configured to control its host playback device to set these configurable parameters in response to detection of any of a variety of events, such as reception of user input requesting a role change via the user interface 113 or reception of a message (e.g., an API call) from the control device 130a requesting a role change, among other events. As shown in FIG. 7, the LEG code and configuration data 702W stored on the playback device 110W is set to operate as a broadcaster and each instance of the LEG code and configuration data 702X-702Z is set to operate as a receiver. However, it should be noted that each of the playback devices 110W-110Z is capable of operating as a broadcaster or a receiver by virtue of the LEG code and configuration data 702 stored thereon. Moreover, it should be noted that a LEG group may include as few as two playback devices, in some examples.

Continuing with examples illustrated by FIG. 7, playback devices set to operate as LEG broadcasters, such as the playback device 110W, are configured to broadcast audio to other devices per the PBP. LEG broadcasters are also configured to send BLUETOOTH LE undirected or periodic advertisements to announce their state and availability to potential LEG receivers. LEG broadcasters are further configured to accept connections from LEG receivers on a transient or broadcast-specific basis and to initiate or update audio control such as volume, play/pause, track control (including seeking to a particular point in the track), or broadcaster handoff, as will be described further below.

In some examples, playback devices set to operate as LEG receivers, such as the playback devices 110X-110Z, are configured to receive audio from another device via the PBP. In these examples, LEG receivers are configured to detect any of a variety of user input and, in response thereto, scan for a LEG broadcaster's advertisements to detect the broadcast's state. LEG receivers are also configured to attempt to join a broadcast if a LEG broadcaster is available. LEG receivers may be further configured to initiate discrete connections to a single LEG Broadcaster on a transient or broadcast-specific basis to initiate or update audio control such as volume, play/pause, track control, or broadcaster handoff, as will be described further below.

Continuing with the system 700, the group management layer 708 is configured to handle playback device group formation, maintenance, and dissolution. In some examples, the group management layer 708 remains inactive when its host playback device is in an idle state (e.g., not playing back audio). This feature conserves power as the group management layer 708 will not commence radio (e.g., BLUETOOTH radio) activity for group formation until a trigger is detected. Triggers that the group management layer 708 is configured to detect vary by implementation and operating role.

For instance, in some examples where the LEG code and configuration data 702 is set to operate as a broadcaster (e.g., the LEG broadcaster 702W), the group management layer 708 can detect active audio playback as a trigger to commence radio activity and advertise LEG broadcast services in response to such detection. In this situation, the detected active audio playback may be a request to start playback (e.g., received via the user interface 113 or from the control device 130a) and/or playback requested prior to, and continuing after, initiation of broadcaster role operation. In some examples, to advertise LEG broadcast services the LEG broadcaster 702W transmits BLUETOOTH LE undirected advertisements that communicate its state and availability. These advertisements can result in a LEG receiver (e.g., the LEG receiver 702X) joining a LEG group, as will be described further below.

In some examples, where the LEG code and configuration data 702 is set to operate as a receiver (e.g., the LEG receiver 702X), the group management layer 708 can detect a power on of the playback device 110X as a trigger to commence radio activity and start scanning for LEG broadcasts for a configurable timeout period (e.g., 10 minutes). In these examples, the group management layer 708 is further configured to halt scanning to conserve power if no LEG broadcasts are joined within the timeout period. Alternatively or additionally, in certain examples, the LEG receiver 702X can detect user input specifying a request to group (e.g., selection of a group button or reception of a voice command via the user interface 113, receipt of a message from the control device 130a indicating that the user selected a grouping control via the user interface 133, etc.) as a trigger to begin scanning for LEG broadcasts. Alternatively or additionally, in some examples, the LEG receiver 702X can detect, as a trigger to begin scanning for LEG broadcasts, that its host playback device is within a threshold proximity of another playback device. The LEG receiver 702X may detect the threshold proximity, for example, in response to reception of a proximity signal from the network interface 112d or the transducer 722 (e.g., Hall effect sensor, an RFID or NFC scanner, a UWB sensor, an accelerometer, etc.) included within the playback device 110X. The proximity signal may or may not encode information helpful to join a LEG group and may be required to transgress a threshold strength, such as a threshold received signal strength indicator (RSSI) value, or manifest other characteristics (e.g., indicate that the host device was brought into physical contact with another playback device, where the proximity signal is a motion signal). Reception of any of the triggers described above may result in the LEG receiver 702X joining a LEG group. Moreover, in some examples, rather than controlling the playback device 110X to scan for LEG broadcasts in response to detection of a proximity signal, the LEG receiver 702X may process information encoded within the proximity signal to join a LEG group and/or control the playback device 110X to prompt, or to request the control device 130a to prompt, a user to confirm that joining a LEG group is desired.

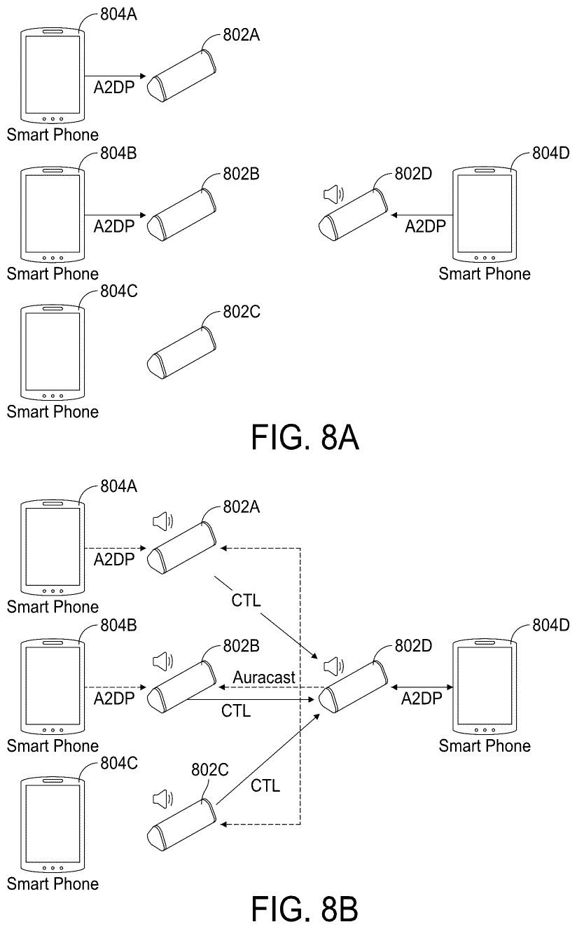

Turning to FIGS. 8A and 8B, an example of LEG group formation is illustrated. As shown, FIGS. 8A and 8B depict a plurality of playback devices 802A-802D and a plurality of control devices 804A-804D. Each of the playback devices 802A-802D may be implemented by one of the playback devices 110W-110Z of FIG. 7 and each of the control devices 804A-804D may be implemented by an instance of the control device 130a introduced in FIG. 1A. As shown in FIG. 8A, each playback device of the plurality of playback devices 802A, 802B, and 802D has an A2DP connection with a corresponding, respective control device 804A, 804B, and 804D. The playback device 802C is powered off and has no connection to its corresponding control device 804C. Although each of the playback devices 802A-802D has LEG code and configuration data (e.g., the LEG code and configuration data 702 of FIG. 7) installed thereon, no instance of the LEG code has been set to operate as either a LEG broadcaster or a LEG receiver. Given this configuration, each playback device is configured to play back audio streamed thereto via the A2DP connection between the playback device and its corresponding control device. In other words, as shown in FIG. 8A, no playback device of the plurality of playback devices 802A-802D is grouped with another playback device of the plurality of playback devices 802A-802D. Moreover, as shown in FIG. 8A, the playback device 802D is actively playing back audio streamed thereto by the control device 804D.

Continuing with examples illustrated by FIGS. 8A and 8B, the playback device 802D receives a message (e.g., an API call) originating from the control device 804D specifying a request to assume a LEG broadcaster role. For instance, in some examples, a user interface of the control device 804D receives user input, such as a tap or other touchscreen gesture, selecting a user interface control configured to initiate a LEG broadcast. In these examples, the control device 804D communicates the request message to assume the LEG broadcaster role to the playback device 802D in response to reception of the user input. In response to receiving the request message, the playback device 802D sets the role of the LEG code and configuration data to a LEG broadcaster role. In some examples, upon assuming the broadcaster role, the playback device 802D detects its ongoing audio playback of data streamed from the control device 804D as a trigger to advertise (e.g., via BLUETOOTH advertisements in accord with the PBP) its availability as a broadcast service.

Continuing with examples illustrated by FIGS. 8A and 8B, each of the playback devices 802A-802C receives user input specifying a request to assume a LEG receiver role. For instance, in some examples, a user interface 113 of the playback device 802A receives user input, such as a button press, selecting a group button configured to initiate LEG reception. In some examples, a user interface 113 of the playback device 802B receives user input, such as a voice command, requesting initiation of LEG reception. In some examples, a user interface 113 of the playback device 802C receives user input, such as a button press, selecting a power button. In this situation, the playback device 802C was configured as a LEG receiver prior to being previously powered down and, as such, selection of the power button acts as a request to enter the LEG receiver role. In response to reception of the respective user input described above, each of the playback devices 802A-802C sets the role of its LEG code and configuration data to a LEG receiver role. In some examples, upon assuming the receiver role, each of the playback devices 802A-802C scans for and detects advertisements from the playback device 802D and joins the LEG group via execution of its CTL 710, as will be described further below.

FIG. 8B illustrates the LEG group after formation. As shown by FIG. 8B, the LEG group is established and maintained by both BLUETOOTH features and proprietary LEG features. For instance, in the illustrated example, the playback device 802D broadcasts an audio stream to the playback devices 802A-802C via a BIG and communicates with each of the playback devices 802A-802C via control messages communicated by the CTL 710 of the playback devices 802A-802D. When operating as shown in FIG. 8B, the playback device 802D, as the LEG broadcaster, receives an audio stream from the control device 804D, broadcasts the audio stream to the playback devices 802A-802C via the BIG, and the LEG group consisting of the playback devices 802A-802D render the audio stream in synchrony. It should be noted that, as shown in FIG. 8B, the A2DP connections between the control devices 804A and 804B and the playback devices 802A and 802B have been dissolved, or paused, in favor of participation of the playback devices 802A and 802B in the BIG and LEG group.

Pseudocode examples of code executed during LEG group formation follow.

```
Def broadcaster( ):
  begin_connectable_periodic_broadcast( )
    known_receivers = { }
    loop( ):
    connect_event = wait_for_connection( )
    If authenticated(connect_event.device) != success:
      add_to_blacklist(connect_event.device)
      disconnect(connect_event.device)
      continue
    send_slot_response_number(connect_event.device)
    known_receivers.append(connect_event.device)
    disconnect(connect_event.device)
Def receiver( ):
  broadcaster = None
  While broadcaster.is_none( ):
    Scan_event = scan_for_advertisement( )
    If connect(scan_event.device) == success:
      If authenticate(scan_event.device) == success:
        broadcaster = scan_event.device
        Slot_response_number = get_slot( )
```

In some examples, once a LEG group is established, a member playback device must lose power, move outside of radio frequency range of the LEG Broadcaster, or receive user input specifying a request to exit the LEG group.

Returning to examples illustrated by FIG. 7, the audio control layer 706 may be configured to handle requests to adjust LEG volume, play/pause/repeat, track control, stereo/mono settings, etc. For instance, in some examples, the user interface 113 of the playback device 110W, which is acting as a LEG broadcaster, may receive user input specifying a volume increase. In these examples, the audio control layer 706 may receive the user input and adjust the volume of the BIG in response thereto. In other examples, the user interface 113 of the playback device 110X, which is acting as a LEG receiver, may receive user input specifying a volume increase. In these examples, the audio control layer 706 of the playback device 110X may receive the user input and interoperate with the CTL 710 of the playback device 110X to transmit a control message specifying the volume increase to the CTL 710 of the playback device 110W. The CTL 710 of the playback device 110W may receive and pass the control message to the audio control layer 706 of the playback device 110W, and the audio control layer 706 may adjust the volume of the BIG in response thereto. It should be noted that, prior to passing the control message to the audio control layer 706, the CTL 710 of the playback device 110W may authenticate the playback device 110X using technology described below.

Continuing with examples illustrated by FIG. 7, in some examples the LEG receivers 702X-702Z are configured to join a LEG Broadcast via execution of the CTL 710. More specifically, in these examples, each of the LEG receivers 702X-702Z is configured to communicate one or more messages to the LEG Broadcaster 702W via execution of its CTL 710. Each request may specify a request to join the broadcast (e.g., a request to join the BIG by exchanging BLUETOOTH LE messages specified by PBP). The LEG broadcaster 702W, in turn, is configured to process each of the request messages via execution of its CTL 710. This processing may include reception of the request messages, parsing each of the request messages to retrieve data specified therein, and generating and communicating a respective acknowledgement message to each respective LEG receiver 702X-702Z. Moreover, the LEG broadcaster 702W may be further configured to track the number of LEG receivers that are active, restrict the number of LEG receivers to a maximum group size (e.g., 8, 10, 18, or 32 members) and activate the BIG if the number of receivers was previously 0.

In some examples, the CTL 710 is configured to establish bidirectional communication links between LEG group members (e.g., the LEG broadcaster 702W and the LEG receivers 702X-702Z). In these examples, the CTL 710 is configured to allow the LEG receivers 702X-702Z to communicate, via these bidirectional communication links, control messages (e.g., link quality feedback, audio commands, keepalive messages, etc.) to the LEG broadcaster 702W. As one example, each CTL 710 of the LEG receivers 702X-702Z may be configured to communicate periodic keepalive messages to the CTL 710 of the LEG broadcaster 702W to indicate continued participation in the LEG group. The periodicity of the keepalive message may vary between examples and may range from a message every second to a message every two minutes or longer. In these examples, the CTL 710 of the LEG broadcaster 702W is configured to determine whether at least one keepalive message has been received before expiration of a configurable timeout period (e.g., 5 minutes). According to this configuration of the CTL 710 of the LEG broadcaster 702W, if no keepalive message is received prior to expiration of the timeout period, the CTL 710 of the LEG broadcaster 702W dissolves the LEG group to avoid wasting power.

Various examples of the CTL 710 are configured to implement bidirectional communication links in a variety of ways. For instance, in some examples, the CTL 710 is configured to implement one or more bidirectional communication links using BLUETOOTH LE asynchronous connection-oriented logical transport (ACL) links that persist until the LEG group is dissolved. In these examples, each respective CTL 710 of the LEG receivers 702X-702Z is configured to initiate and maintain an ACL to the CTL 710 of the LEG broadcaster 702W while the BIG is active. This ACL-only-based configuration enables reliable bidirectional transport, low latency for sending messages, efficient scheduling by the underlying BLUETOOTH LE interface, and inherent keepalive message communication according to a connection interval parameter negotiated by the playback devices during ACL link initialization. However, the number of active ACL links may be limited, for example, based on the version of the BLUETOOTH interface included in the network interface 112d. As such, the number of playback devices 110X-100Z may be likewise limited under this ACL-only-based configuration.

In some examples, the CTL 710 is configured to implement one or more bidirectional communication links using ad-hoc ACL links that are initiated to communicate one or more control messages and that are torn down thereafter. In these examples, each respective CTL 710 within the LEG receivers 702X-702Z is configured to limit the number of ACL links that are necessary in the LEG group by initiating an ad-hoc ACL link only when a LEG receiver has a control message to distribute to the LEG group via the LEG broadcaster 702W. In some of these examples, one or more of the respective CTLs 710 of the LEG receivers 702X-702Z is configured to not send keepalive messages to the LEG broadcaster 702W using an ad-hoc ACL but are instead configured to advertise keepalive messages periodically. While this ad-hoc-ACL-based configuration may reduce the number of ACL links active at a given time, the configuration also adds latency to control message execution due to the time required to set up an ad-hoc ACL link for each control message. Further, this ad-hoc-ACL-based configuration may result in ACL link bottlenecks where one or more of the LEG receivers 702X-702Z initiates the maximum number of ad-hoc ACL links at the same time. This bottleneck may introduce latency, which may be further exacerbated by back off times necessitated when the maximum number of ACL links is reached and/or to enable slower executing LEG receivers to reliably initiate ad-hoc ACL links.

In some examples, the CTL 710 is configured to implement one or more bidirectional communication links using BLUETOOTH advertisements only. In these examples, each respective CTL 710 of the LEG receivers 702X-702Z is configured to transmit control messages to the CTL 710 of the LEG broadcaster 702W via advertisements, and the LEG broadcaster 702W is configured to respond thereto via responsive advertisements. While this advertisement-based configuration can scale to large number of LEG receivers and is supportable by nearly all BLUETOOTH interfaces, control messages sent via advertisements are not inherently reliable or intelligently schedulable due to limitations of the media access control available in BLUETOOTH interfaces. As such, in these examples, each CTL 710 includes additional code configured to enable reliable control message delivery even through advertisements, such as by adding code that checks for successful delivery of packets and reacts to transmission problems by requesting retransmission of dropped packets and ignoring duplicate packets. Additionally, as advertisements are communicated through a limited subset of the available radio frequency spectrum, advertisements are more likely to experience contention and dropped packets than other BLUETOOTH transmissions under this advertisement-based configuration.

In some examples, the CTL 710 is configured to implement one or more bidirectional communication links using BLUETOOTH LE Periodic Advertising with Response (PAwR) as described in the BLUETOOTH Core Specification Version 5.4, which is hereby incorporated herein by reference. In these examples, the CTL 710 of the LEG broadcaster 702W is configured to operate as a central according to PAwR and each of the layers 706 of the LEG receivers 702X-702Z is configured to operate as a peripheral according to PAwR. In these examples, the CTL 710 of the LEG broadcaster 702W is configured to negotiate with each CTL 710 of the LEG receivers 702X-702Z to establish a distinct slot interval for communications between the LEG broadcaster 702W and each respective LEG receiver of the LEG receivers 702X-702Z. This negotiation may be conducted, for example, via a temporary ACL link that is both established and torn down during initialization of the LEG group. After initialization is complete, each of the LEG receivers 702X-702Z can transmit control messages to the LEG broadcaster 702W, and the LEG broadcaster 702W may respond thereto during a respective slot interval reserved for each of the LEG receivers 702X-702Z in accordance with PAwR. It should be noted that this PAwR-based configuration of the CTL 710 addresses the ACL bottleneck issues described above with reference to the ad-hoc-ACL-based configuration and enables more data to be sent in a bidirectional manner but without requiring a relatively persistent ACL link. Moreover, this PAwR-based configuration consumes less power than other configurations, in some situations (e.g., where the number of control messages are relatively high). However, as PAwR is a relatively new feature, this configuration may not be available to certain hardware configurations (e.g., where the BLUETOOTH interface included in the network interface 112d fails to support PAwR).

In some examples, the CTL 710 is configured to monitor link quality within the LEG group and to adjust operational parameters of the group to minimize power consumption while maintaining a desired level of broadcast performance. In these examples, each respective CTL 710 of the LEG receivers 702X-702Z is configured to accumulate link quality data (e.g., number of dropped packets, RSSI, etc.) and periodically transmit control messages specifying the link quality data to the CTL 710 of the LEG broadcaster 702W. Further, in these examples, the CTL 710 of the LEG broadcaster 702W is configured to receive and analyze the link quality data and adjust operational parameters of the LEG group based on the analysis. For instance, in some examples, the CTL 710 of the LEG broadcaster 702W is configured to determine whether the minimum RSSI value recorded at the LEG receivers 702X-702Z is above a threshold value and, if so, decrease the transmission power used to broadcast audio streams to the the LEG receivers 702X-702Z. Other operational parameters that the CTL 710 of the LEG broadcaster 702W may be configured to adjust include retransmission count and encoding quality, among others. In some examples, lowering the encoding quality may result in fewer audio dropouts.

It should be noted that the particular configuration of the CTL 710 used may vary based on the characteristics of the LEG group or individual LEG group members supported by the CTL 710. For instance, in some examples, the CTL 710 may be configured to use the PAwR-based configuration when implementing bi-directional communication links involving playback devices rendering in mono, but may also be configured to use the ACL-based configuration when implementing bi-directional communication links involving playback devices rendering in stereo.

In certain examples, the CTL 710 is configured to support authentication of playback devices operating as LEG receivers (e.g., the playback devices 110X-110Z) within a LEG group with a playback device operating as a LEG broadcaster (e.g., the playback device 110W) within the LEG group. For instance, in some examples, the CTL 710 is configured to a public key infrastructure, such as Datagram Transport Layer Security over BLUETOOTH LE. In these examples, cryptographic information (e.g., public/private keys, certificates, etc.) may be stored on the playback devices 110W-110Z at a secure memory location (e.g., a trusted platform module, the LEG data store 704, etc.) during manufacture of the playback devices 110W-110Z. Additionally or alternatively, the cryptographic information may be generated based on information regarding a LEG broadcaster and information regarding the playback device to ensure that only authorized playback devices (e.g. playback devices from a particular manufacturer) may authenticate to, and potentially communicate control messages to, the LEG. Additionally or alternatively, some instances of the CTL 710 are configured to implement Encrypted Advertising Data as described in the BLUETOOTH Core Specification Version 5.4. Other authentication configurations may be utilized in some examples. For instance, in some examples, the CTL 710 interoperates with the transducers 722 and/or the transducers 114 via the OOB interface 720 to authenticate devices using acoustic signaling, NFC, and/or UWB. Example setup procedures where the transducers can be used to transfer setup information such as a PIN, an account identifier, or other data are described in U.S. Patent Pub. No. 2022/0104015, filed Sep. 24, 2021, titled “Intelligent Setup for Playback Devices,” which is hereby incorporated herein by reference in its entirety. Further, in some examples, the CTL 710 may grant or revoke authorization to particular playback devices to request particular audio commands, broadcaster handoff, etc. For instance, in some examples, the CTL 710 receives security policy data from the control device 130a, store the policy data in the LEG data store 704, and applies the policy data to grant or revoke authorizations to playback devices.

In some examples, the CTL 710 is configured to keep its host playback device within a LEG group unless the host loses power or receives user input specifying a request to remove the host from the LEG group. In these examples, the CTL 710 of the playback device 110W is configured to select a backup LEG broadcaster and communicate an identifier of the backup to LEG receivers as LEG receivers enter the LEG group and in response to various events detected thereafter, such as expiration of a timer or a detected change in environment (e.g., RSSI measures that deviate from established values by more than a threshold). The CTL 710 of the backup is configured to detect an unexpected cessation of operation of the LEG broadcaster (e.g., by not receiving messages from the LEG broadcaster for a time period in excess of a timeout period) and to switch the backup from a LEG receiver to a LEG broadcaster for the LEG group should the playback device 110W unexpectedly cease operation, thereby preventing dissolution of the LEG group. In some examples, the CTL 710 of the playback device 110W is configured to select the backup based on an optimization heuristic. In particular examples, the optimization heuristic is derived from an RSSI or acoustic signal strength measured between devices in the LEG group. For instance, the optimization heuristic may execute a triangulation process based on the RSSI and/or acoustic signal strength measurements. It should be noted that, in certain examples, the CTL 710 is configured to limit selection of a backup LEG to one instance. In these examples, a LEG broadcaster that was initiated from a backup will not select a backup. In these examples, unexpected failure of the LEG broadcaster will cause the LEG group to dissolve. This feature may prevent non-intuitive grouping behavior harmful to the user experience.

In some examples, the CTL 710 is configured to execute a broadcaster handoff process through which an existing LEG group is transitioned from a first, “old” broadcaster to a second, “new” broadcaster. The broadcaster handoff process is a feature that is important to ensure a high quality user experience in group settings.

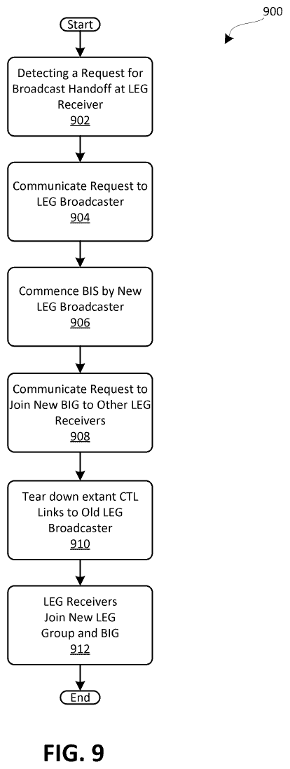

One example of a broadcaster handoff process 900 is illustrated in FIG. 9. As shown in FIG. 9, the process 900 starts with a LEG receiver (e.g., the LEG receiver 702X of FIG. 7) detecting 902a request for the LEG group to handoff the current broadcast from an old broadcaster (e.g., the playback device 110W of FIG. 7) to a new broadcaster (e.g., the LEG receiver 702X of FIG. 7). For instance, in some examples, a user interface 113 of the playback device 110X may detect user input selecting a broadcast button of the user interface 113, and the user interface 113 may pass the input to the LEG receiver for processing. The LEG receiver, in turn, may generate a handoff request in response to the input and pass the request to the CTL 710 of the LEG receiver for processing. Alternatively or additionally, the LEG receiver may detect an audio stream (e.g., an A2DP stream) inbound from a control device (e.g., the control device 130a introduced in FIG. 1A), or inbound from another audio source, via the network interface 112d, and the LEG receiver may generate a handoff request and pass the request to the CTL 710 of the LEG receiver for processing.

Continuing with the process 900, the LEG receiver communicates 904 the handoff request to the old broadcaster. For instance, in some examples, the LEG receiver transmits a message to the old broadcaster via the CTL 710 of both devices.

Continuing with the process 900, the LEG receiver switches roles from a LEG receiver to a LEG broadcaster and commences 906a new BIG that conveys new audio. For instance, in some examples, the LEG receiver sets configuration data stored in a LEG data store (e.g., the LEG data store 704 of the LEG receiver 702X of FIG. 7) to record the playback device 110X as the new LEG broadcaster. Further, in these examples, as the new LEG broadcaster, the playback device 110X controls the network interface 112d, which includes a BLUETOOTH interface, to initiate one or more new BISs that transport the new audio and advertises its broadcast services.

Continuing with the process 900, the old LEG broadcaster communicates 908a message to LEG receivers that are currently part of its old LEG group (e.g., the LEG receivers of FIG. 7 which do not include the new LEG broadcaster hosted by the playback device 110X). The message may specify a request for the LEG receivers to join a new LEG group established by the new LEG broadcaster. For instance, in some examples, the old LEG broadcaster transmits the request message to the current LEG receivers via its CTL 710 and the respective CTLs 710 of the current LEG receivers in the old LEG group.

Continuing with the process 900, each respective CTL 710 of the current LEG receivers detects the request message communicated in the operation 908, parses the request message, and (in response thereto) joins the new LEG group. The process of joining the new LEG group may include tearing down 910 extant CTL links to the old LEG broadcaster and joining 912 the new BIG and LEG group. The particular operations executed within the operation 912 may include joining the BIG in accord with PBP, establishing CTL links per the configuration of the CTL 710 used within the LEG group, and rendering audio in synchrony with other members of the new LEG group. Subsequent to the operation 912, the process 900 may end.

It should be noted that the process 900 enables broadcast handoff with a single user interaction, thereby improving the user experience.

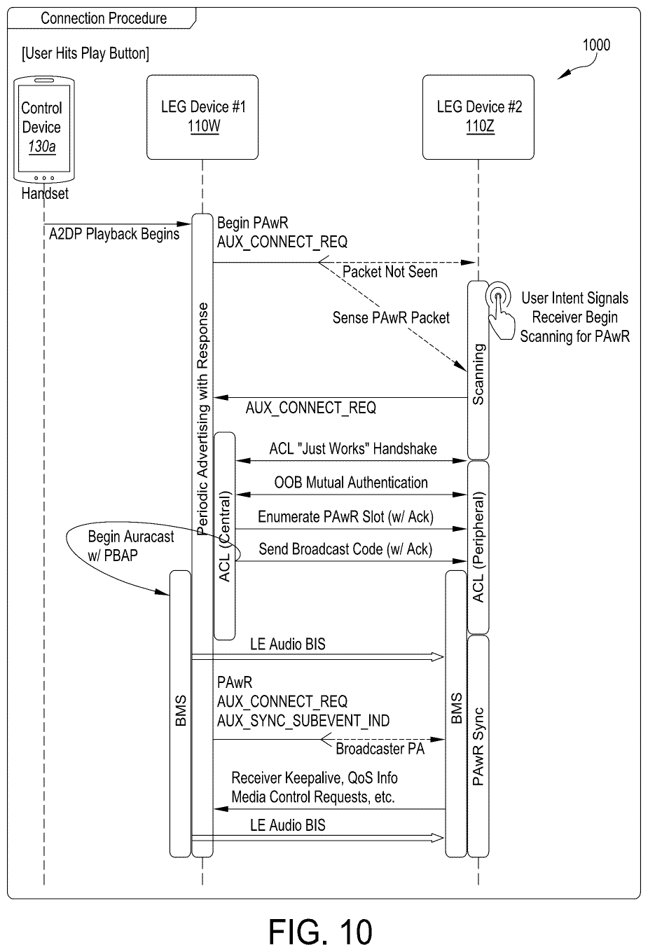

Turning now to FIG. 10, another method of establishing a LEG group executed by some examples of the system 700 introduced in FIG. 7 is illustrated. As shown in FIG. 10, the process 1000 begins with the control device 130a receiving user input selecting a play button. In response to reception of the user selection, the control device 130a interoperates with the playback device 110W to establish an A2DP link and the playback device 110W begins playing back audio.

Continuing with the process 1000, the playback device 110W begins PAwR operation, which includes transmission of AUX_CONNECT_REQ packets. The playback device 110Z receives user input specifying a request to join a LEG group. In response to reception of the input, the playback device 110Z commences scanning. The playback device 110Z detects an AUX_CONNECT_REQ packet and responds thereto.

Continuing with the process 1000, the playback device 110W responds to the playback device 110Z by initiating an ACL link with the playback device 110Z. Within the ACL link, the playback device 110W authenticates playback device 110Z and, as a central within the PAwR scheme, negotiates a PAwR Slot with the playback device 110Z, which is a peripheral within the PAwR scheme. Further, within the ACL link, the playback device 110W sends a broadcast code to the playback device 110Z and begins a broadcast using the PBP.

Continuing with the process 1000, the playback device 110W interoperates with the playback device 110Z to tear down the ACL link. The playback device 110W takes on the role of a broadcast media sender (BMS) and transmits one or more BISs to the playback device 110Z, which is operating in the role of a broadcast media receiver (BMR). The playback device 110Z communicates control messages to the playback device 110W within the negotiated PAwR slot. The playback device 110W receives the control messages and adapts the one or more BISs based thereon.

As noted above, the low energy grouping (LEG) technology disclosed herein supplements and extends PBP and other BLUETOOTH LE features to achieve a number of objectives for a user's experience. LEG implements a control plane that enables bidirectional, wireless, and routerless communications between playback devices. Through LEG a user can group or ungroup playback devices easily and quickly, with or without a separate control device. In addition, a user can switch the active source of audio dynamically, while maintaining a prior grouping of playback devices. LEG is power optimized and enables handoff between sources of audio while minimizing unnecessary beaconing and scanning. LEG sets many parameters that affect power consumption to a minimum initial state and scales up as needed to achieve the desired user experience, rather than setting the parameters to a high or maximum initial state and scaling down as permitted. LEG receivers can detect and quantify broadcast performance into one or more metrics and communicate the metrics to the LEG broadcaster. The LEG broadcaster can, in turn, adjusts transmission parameters such as retransmission count, encoding quality/type, and transmission power level to minimize power consumption while achieving desired audio performance. LEG authenticates playback devices and supports security policies that permit or prevent playback devices from effecting the LEG group. LEG supports a variety of playback device groupings, such as synchrony groups, bonded groups, and stereo pairs. Through these and other features, LEG enhances the experience of users who wish to enjoy audio through a group of BLUETOOTH-enabled playback devices.

### V. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods. Moreover, it should be appreciated that changes, adjustments, alterations, modifications, or the like of any of the parameters described herein may manifest in a new stored value for the affected parameter. The new stored value may affect operation of the playback device to which the parameter is applicable.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. Example Features

The following examples pertain to further embodiments, from which numerous permutations and configurations will be apparent.

Example 1 is a playback device comprising one or more processors. The playback device further comprises one or more communication interfaces operably connected to the one or more processors and configured to facilitate communication over at least one network. The playback device further comprises at least one non-transitory computer-readable medium comprising program instructions that are executable by the one or more processors. The playback device is configured to establish a Broadcast Isochronous Group (BIG) comprising at least one other playback device, the BIG comprising at least one Broadcast Isochronous Stream (BIS) communicating an audio channel; establish a least one bidirectional link with the at least one other playback device; play back, at a volume level, the audio channel in synchrony with the at least one other playback device; receive, via the at least one bidirectional link, a request to change the volume level; change the volume level to a new volume level in response to reception of the request, and play back, at the new volume level, the audio channel in synchrony with the at least one other playback device.

Example 2 is a playback device comprising one or more processors; one or more communication interfaces operably connected to the one or more processors and configured to facilitate communication over at least one network; and at least one non-transitory computer-readable medium comprising program instructions that are executable by the one or more processors such that the playback device is configured to: establish a Broadcast Isochronous Group (BIG) comprising at least one other playback device, the BIG further comprising one or more Broadcast Isochronous Streams (BISs) communicating one or more audio channels; establish at least one bidirectional link with the at least one other playback device; play back, at a volume level, at least one audio channel of the one or more audio channels in synchrony with the at least one other playback device; receive, via the at least one bidirectional link, a request to change the volume level; change the volume level to a new volume level in response to reception of the request; and play back, at the new volume level, the at least one audio channel of the one or more audio channels in synchrony with the at least one other playback device.

Example 3 includes the subject matter of example 2, wherein: the playback device is a member of a low energy grouping (LEG) group comprising the playback device, the at least one other playback device, and an another playback device; and the instructions are executable by the one or more processors such that the playback device is further configured to: receive, via the at least one bidirectional link, a request to handoff the LEG group from the playback device to the at least one other playback device; and hand off the LEG group to the at least one other playback device.

Example 4 includes the subject matter of example 3, wherein to hand off the LEG group comprises to: communicate, to the other playback device, a request to join a new LEG group; and tear down a control link between the playback device and the other playback device.

Example 5 includes the subject matter of any of examples 2-4, wherein the instructions are executable by the one or more processors such that the playback device is further configured to: receive, via the at least one bidirectional link, link quality data; and adjust, based on the link quality data, one or more operational parameters.

Example 6 includes the subject matter of example 5, wherein the link quality data comprises data specifying one or more of a number of dropped packets or a received signal strength indicator (RSSI) value.

Example 7 includes the subject matter of either example 5 or example 6, wherein the one or more operational parameters comprise one or more of transmission power, retransmission count, or encoding quality.

Example 8 includes the subject matter of any of examples 5 through 7, wherein to adjust the one or more operational parameters comprises to: determine whether a minimum RSSI value received within the link quality data is above a threshold value; and decrease transmission power based on a determination that the a minimum RSSI value is above the threshold value.

Example 9 includes the subject matter of any of examples 2-8, wherein to change the volume level comprises to authenticate the at least one other playback device.

Example 10 includes the subject matter of any of examples 2-9, wherein: the one or more BISs comprise a first BIS communicating a first audio channel of the one or more audio channels and a second BIS communicating a second audio channel of the one or more audio channels; and to play back the at least one audio channel of the one or more audio channels comprises to play back the first audio channel in synchrony with playback of the second audio channel by the at least one other playback device.

Example 11 includes the subject matter of example 10, wherein: the first audio channel is a first stereo channel; and the second audio channel is a second stereo channel.

Example 12 includes the subject matter of any of examples 2-11, wherein the one or more audio channels comprise a mono audio channel.

Example 13 includes the subject matter of any of examples 2-12, wherein the instructions are executable by the one or more processors such that the playback device is further configured to: receive, via the at least one bidirectional link, a request to play back to a new audio track; in response to reception of the request, cease communicating the one or more audio channels; and communicate, via the one or more BISs, one or more new audio channels of the new audio track; and play back at least one new audio channel of the one or more new audio channels in synchrony with the at least one other playback device.

Example 14 includes the subject matter of any of examples 2-13, wherein the instructions are executable by the one or more processors such that the playback device is further configured to: receive, via the at least one bidirectional link, a request to pause playback of the at least one audio channel; and pause playback of the at least one audio channel in synchrony with the at least one other playback device.

Example 15 includes the subject matter of any of examples 2-14, wherein the instructions are executable by the one or more processors such that the playback device is further configured to: receive, via the at least one bidirectional link, a request to repeat playback of the at least one audio channel; and repeat playback of the at least one audio channel in synchrony with the at least one other playback device.

Example 16 is a low energy grouping (LEG) group of playback devices comprising: a first playback device configured to operate as a LEG receiver; a second playback device configured to operate as a LEG receiver; and a third playback device configured to operate as a LEG broadcaster, the third playback device being configured to establish a Broadcast Isochronous Group (BIG) comprising the first playback device and the second playback device, the BIG further comprising one or more Broadcast Isochronous Streams (BISs) communicating one or more audio channels, establish a first bidirectional link with the first playback device, establish a second bidirectional link with the second playback device, receive, via the first bidirectional link, a request to change a parameter applicable to one or more of the first playback device, the second playback device, or the third playback device, and change the parameter in response to reception of the request; and play back at least one audio channel of the one or more audio channels in synchrony with the first playback device and the second playback device.

Example 17 includes the subject matter of example 16, wherein the third playback device is further configured to: select either the first playback device or the second playback device as a backup LEG broadcaster; and communicate an identifier of the backup LEG broadcaster to members of the LEG group.

Example 18 includes the subject matter of example 17, wherein the backup LEG broadcaster is configured to: detect cessation of operation of the third playback device; and switch from a LEG receiver to a LEG broadcaster in response to detection of cessation of operation of the third playback device.

Example 19 includes the subject matter of any of examples 16-18, wherein the third playback device is configured to: receive, via the first bidirectional link, a request to handoff the LEG group to the second playback device; and hand off the LEG group to the second playback device.

Example 20 includes the subject matter of example 19, wherein to hand off the LEG group to the second playback device comprises to: communicate, to the first playback device, a request to join a new LEG group; and tear down a control link between the third playback device and the first playback device.

Example 21 includes the subject matter of example 20, wherein the second device is configured to establish a new BIG comprising the first playback device, the BIG further comprising one or more new BISs communicating one or more new audio channels; establish a first bidirectional link with the first playback device; and play back at least one audio channel of the one or more audio channels in synchrony with the first playback device.

Example 22 includes the subject matter of example 21, wherein the first device is configured to: receive the request to join the new LEG group; and join the new BIG in response to reception of the request to join the new LEG group.

1. A playback device comprising:
one or more processors;
one or more communication interfaces operably connected to the one or more processors and configured to facilitate communication over at least one network; and
at least one non-transitory computer-readable medium comprising program instructions that are executable by the one or more processors such that the playback device is configured to:
establish a Broadcast Isochronous Group (BIG) comprising at least one other playback device, the BIG further comprising one or more Broadcast Isochronous Streams (BISs) communicating one or more audio channels;
establish at least one bidirectional link with the at least one other playback device;
play back, at a volume level, at least one audio channel of the one or more audio channels in synchrony with the at least one other playback device;
receive, via the at least one bidirectional link, a request to change the volume level;
change the volume level to a new volume level in response to reception of the request; and
play back, at the new volume level, the at least one audio channel of the one or more audio channels in synchrony with the at least one other playback device.

2. The playback device of claim 1, wherein:
the playback device is a member of a low energy grouping (LEG) group comprising the playback device, the at least one other playback device, and an another playback device; and
the instructions are executable by the one or more processors such that the playback device is further configured to:
receive, via the at least one bidirectional link, a request to handoff the LEG group from the playback device to the at least one other playback device; and
hand off the LEG group to the at least one other playback device.

3. The playback device of claim 2, wherein to hand off the LEG group comprises to:
communicate, to the other playback device, a request to join a new LEG group; and
tear down a control link between the playback device and the other playback device.

4. The playback device of claim 1, wherein the instructions are executable by the one or more processors such that the playback device is further configured to:
receive, via the at least one bidirectional link, link quality data; and
adjust, based on the link quality data, one or more operational parameters.

5. The playback device of claim 4, wherein the link quality data comprises data specifying one or more of a number of dropped packets or a received signal strength indicator (RSSI) value.

6. The playback device of claim 4, wherein the one or more operational parameters comprise one or more of transmission power, retransmission count, or encoding quality.

7. The playback device of claim 4, wherein to adjust the one or more operational parameters comprises to:
determine whether a minimum RSSI value received within the link quality data is above a threshold value; and
decrease transmission power based on a determination that the a minimum RSSI value is above the threshold value.

8. The playback device of claim 1, wherein to change the volume level comprises to authenticate the at least one other playback device.

9. The playback device of claim 1, wherein:
the one or more BISs comprise a first BIS communicating a first audio channel of the one or more audio channels and a second BIS communicating a second audio channel of the one or more audio channels; and
to play back the at least one audio channel of the one or more audio channels comprises to play back the first audio channel in synchrony with playback of the second audio channel by the at least one other playback device.

10. The playback device of claim 9, wherein:
the first audio channel is a first stereo channel; and
the second audio channel is a second stereo channel.

11. The playback device of claim 1, wherein the one or more audio channels comprise a mono audio channel.

12. The playback device of claim 1, wherein the instructions are executable by the one or more processors such that the playback device is further configured to:
receive, via the at least one bidirectional link, a request to play back to a new audio track;
in response to reception of the request,
cease communicating the one or more audio channels; and
communicate, via the one or more BISs, one or more new audio channels of the new audio track; and
play back at least one new audio channel of the one or more new audio channels in synchrony with the at least one other playback device.

13. The playback device of claim 1, wherein the instructions are executable by the one or more processors such that the playback device is further configured to:
receive, via the at least one bidirectional link, a request to pause playback of the at least one audio channel; and
pause playback of the at least one audio channel in synchrony with the at least one other playback device.

14. The playback device of claim 1, wherein the instructions are executable by the one or more processors such that the playback device is further configured to:
receive, via the at least one bidirectional link, a request to repeat playback of the at least one audio channel; and
repeat playback of the at least one audio channel in synchrony with the at least one other playback device.

15. A low energy grouping (LEG) group of playback devices comprising:
a first playback device configured to operate as a LEG receiver;
a second playback device configured to operate as a LEG receiver; and
a third playback device configured to operate as a LEG broadcaster, the third playback device being configured to
establish a Broadcast Isochronous Group (BIG) comprising the first playback device and the second playback device, the BIG further comprising one or more Broadcast Isochronous Streams (BISs) communicating one or more audio channels,
establish a first bidirectional link with the first playback device,
establish a second bidirectional link with the second playback device,
receive, via the first bidirectional link, a request to change a parameter applicable to one or more of the first playback device, the second playback device, or the third playback device, and
change the parameter in response to reception of the request; and
play back at least one audio channel of the one or more audio channels in synchrony with the first playback device and the second playback device.

16. The LEG group of claim 15, wherein the third playback device is further configured to:
select either the first playback device or the second playback device as a backup LEG broadcaster; and
communicate an identifier of the backup LEG broadcaster to members of the LEG group.

17. The LEG group of claim 16, wherein the backup LEG broadcaster is configured to:
detect cessation of operation of the third playback device; and
switch from a LEG receiver to a LEG broadcaster in response to detection of cessation of operation of the third playback device.

18. The LEG group of claim 15, wherein the third playback device is configured to:
receive, via the first bidirectional link, a request to handoff the LEG group to the second playback device; and
hand off the LEG group to the second playback device.

19. The LEG group of claim 18, wherein to hand off the LEG group to the second playback device comprises to:
communicate, to the first playback device, a request to join a new LEG group; and
tear down a control link between the third playback device and the first playback device.

20. The LEG group of claim 19, wherein the second device is configured to:
establish a new BIG comprising the first playback device, the BIG further comprising one or more new BISs communicating one or more new audio channels;
establish a first bidirectional link with the first playback device; and
play back at least one audio channel of the one or more audio channels in synchrony with the first playback device.

21. The LEG group of claim 20, wherein the first device is configured to:
receive the request to join the new LEG group; and
join the new BIG in response to reception of the request to join the new LEG group.
